(19) United States
(12) Patent Application Publication
(10) Pub. No.: US 2025/0205689 A1
(43) Pub. Date: Jun. 26, 2025

(54) POLYOXOMETALATE COMPLEXED METAL OXIDES AND USE THEREOF

(71) Applicant: B. G. Negev Technologies and Applications Ltd., at Ben-Gurion University, Beer Sheva (IL)

(72) Inventors: Nitai LEFFLER, Ein HaShlosha (IL); Ira Alan Weinstock, Ofakim (IL)

(21) Appl. No.: 18/846,937

(22) PCT Filed: Mar. 14, 2023
(86) PCT No.: PCT/IB2023/052481

§ 371 Date: Sep. 13, 2024

Related U.S. Application Data
(60) Provisional application No. 63/319,457, filed on Mar. 14, 2022.
(60) Provisional application No. 63/477,323, filed on Dec. 27, 2022.

(51) Int. Cl. B01J 27/188; B01J 21/06; B01J 23/20; B01J 23/30; B01J 23/34; B01J 23/847; B01J 35/39; B01J 37/04; B01J 37/10; C25B 11/067; C25B 11/077

(52) U.S. Cl. CPC B01J 27/188; B01J 21/066; B01J 23/20; B01J 23/30; B01J 23/34; B01J 23/8474; B01J 35/39; B01J 37/04; B01J 37/10; C25B 11/067; C25B 11/077

(57) ABSTRACT

Complexes of polyoxometalate (POM) cluster anions and nanoparticle (NP) cores, are disclosed, featuring inherent thermodynamic stability at least due to covalent bonds, which attach the POMs to the NP cores. The nanoparticles comprise a plurality of crystalline, polycrystalline or amorphous metal-oxide, metal oxyhydroxide and/or metal hydroxide compounds. The POM and NP, each independently, may comprise one, two, three or more different metal cations, particularly transition or main group metal cations. These complexes are highly soluble in water and inherently stable to oxidation and hydrolysis in a broad pH range. As such, the complexes are useful, inert alia, as improved soluble water-oxidation catalysts and stabilizers of metastable crystals.

### FIELD OF THE INVENTION

The present disclosure relates to complexes comprising polyoxometalate (POM) ligands on the surfaces of crystalline and/or amorphous metal-oxide, oxyhydroxide or hydroxide nanoparticles.

### BACKGROUND

Polyoxometalates (POM) are a large class of discrete polynuclear metal-oxo anions, which are usually formed by early transition metals in high oxidation states. Polyoxometalates are either synthetic or occur naturally as minerals. A large diversity of POM structures is known and potential applications thereof, e.g., in catalysis, bio- and nanotechnology, medical and material sciences, as well as sensors. For example, tungstate-based metal-oxide cluster anions are used for coordinatively binding metal-oxide nanocrystals as the cores of macroanion-like complexes of anatase-TiO₂ and hematite, α-Fe₂O₃, that function as water-soluble “fragments” of their parent bulk-oxide materials. Unlike organic ligands, the bulkier POMs bond directly to a smaller fraction of surface sites, thus, better allowing substrate access.

The vast POM family encompasses molecular species with very diverse sizes (from small dimetalates to clusters comparable to small proteins) and manifold structures (often with highly symmetric topologies) that tend to show rich solution equilibria, significant chemical and thermal stability, and the ability to act as proton-electron sinks due to their fast and reversible proton-coupled redox processes. These properties can usually be fine-tuned at the atomic level through systematic compositional modifications performed in the cluster skeleton. Moreover, the possibility of generating vacant metallic sites in a controlled manner allows polyoxometalates to be used as robust, fully inorganic polydentate ligands toward a range of electrophilic moieties (e.g., transition-metal cations, rare earths, p-block organo-derivatives, etc.), thus paving the way for endowing the clusters with tailored additional properties brought by such electrophiles. The combination of all these features confers an intrinsic multifunctional nature on polyoxometalates.

Metal hydroxides catalyze organic transformations and photochemical processes and serve as precursors for the oxide layers of functional multicomponent devices. However, no general methods are available for the preparation of stable water-soluble POM complexes of metal hydroxide nanocrystals (NCs) that may be more effective in catalysis and serve as versatile precursors for the reproducible fabrication of multicomponent devices.

### SUMMARY

The present disclosure relates to complexes of nanoparticle (NP) cores, which may be, for example, crystalline, polycrystalline or amorphous metal-oxide, metal oxyhydroxide and/or metal hydroxide, and polyoxometalate (POM) ligands, wherein a POM is a negatively charged multinuclear metalate comprising a cluster of metal atoms ligated to, and linked via oxide and/or hydroxy anions and, optionally, other atoms, to the NP core. These complexes are referred to herein, for brevity, as “POM-NP” complexes.

The bulky nature of the polyoxometalate cluster anions and their high negative charge prevent surface access between adjacent NPs. This property of POMs is utilized herein, for example, in obtaining high concentrations, homogeneously dispersed NPs in aqueous solution.

In one aspect, the present disclosure relates to novel POM-NP complexes represented herein by the Formula (I):

(Qₗ[i-POM])ₘ[NPᵣ],
wherein
POM is a polyoxometalate cluster anion;
NP is a plurality of metal oxide, metal oxy-hydroxide and/or metal hydroxide, optionally particulate, compounds;
Q is H, an alkali metal cation or an organic cation;
l is the relative amount of Q, which counter-balance the charge of the POM, and is an integer of 1 to 40;
m is the number of POM ligands bound to an individual NP, and is any number between 1 to 10,000;
r is the number of metal-oxide, metal oxy-hydroxide and/or metal hydroxyde compounds in the NP. r is in a range of from 50 to 6,000,000; and
i is absent or a specific POM isomer.

POM may be presented by the Formula (Ia):

[X_{z}MₚC_{d}O_{y}]ⁿ⁻
wherein, X is H, at least one heteroatom and/or at least one metal atom. For example, X may be at least one heteroatom selected from P, S or Si, or at least one metal atom elected from Cd, Mn or Al.

M in Formula (Ia) is at least one transition and/or main-group metal cation, optionally, in a high oxidation state;

C is H, OH, OH₂, a lower alkyl, lower hydroxyalkyl, lower silylalkyl, lower silylalkoxy and/or carboxylate. For example, C may C1-C3 alkyl, C1-C3 hydroxyalkyl or carboxylate.

z is 0 to 100; p is 6 to 250; d is 6 to 100; and y is 15 to 800.

The nanoparticle core, NP, is a plurality of optionally particulate compounds, selected from:
metal oxides, having the empirical chemical formula represented by Formula (Ib): MᵢM′ⱼM″_{f}Oₖ;
metal oxidy-hydroxides, having the empirical chemical formula represented by Formula (Ic): MᵢM′ⱼM″_{f}Oₖ(OH)ₜ; and/or
metal hydroxides, having the empirical chemical formula represented herein Formula (Id): MᵢM′ⱼM″_{f}(OH)ₜ.

In any of the empirical Formulae (Ib), (Ic) and (Id):
M, M′ and M″, each independently, is a metal cation;
i, j, and f, representing the relative amounts of metal cations M, M′ and M″, respectively, each independently, is 0, an integer or a fraction in the range of from 1 to 20, provided that at least one of I, j, or f is not 0;
k is an integer or a fraction in the range of from 1 to 20, for example, from 1 to 8; and
t is an integer or a fraction in the range of from 1 to 20, for example, from 1 to 8 or from 1 to 3.

The metal cations M, M′ and M″, each independently, in the POM or in the NP, is Li(I), Na(I), K(I), Ag(I), Ba(II), Cd(II), Ca(II), Fe(II), Fe(III), Sr(II), Ti(III), Ti(IV), Zr(IV), Nb(V), Nb(III), Hf(IV), Ta(V), Mn(III), Mn(IV), Mo(II), Mo(III), Mo(IV), Re(II), Re(III), Re(IV), Re(V), Re(VI), Re(VII), W(IV), W(V), V(II), V(III), V(IV), V(V), Cr(III), Cr(IV), Cr(V), Ru(II), Ru(III), Ru(IV), Ru(V), Co(II), Co(III), Rh(I), Rh(III), Ir(IV), Ni(II), Pt(II), Pt(IV), Pd(II), Pd(IV), Zn(II), Cu(I), Cu(II), Pb(II), Pb(IV), Al(II), Al(III), Ga(II), Ga(III), In(III), Sn(II), Sn(IV), Sc(II), Sc(III), Au(IV), Au(V), Au(VI) or Ce(IV).

In some embodiments, M in POM is V, Nb, Mo and/or W.

In some embodiments, the NP comprises M, M′ and/or M″, wherein each independently, is Ta(IV), Ti(IV), Mn(III), Mn(IV), Cr(III), Cr(IV), Cr(V), Ru(II), Ru(III), Ru(IV), Ru(V), Co(II), Co(III), Rh(I), Rh(III), Ni(II), Zn(II), Cu(II), Al(III), Ga(III), In(III), Fe(II), Fe(III), Nb(V), Nb(III), Hf(IV), Ce(IV), Zr(IV), Ba(II), Li(I), K(I), Sc(II), Sc(III), Sn(II) or Sn(IV).

In some embodiments, any of the metal oxide, metal oxy-hydroxide or metal hydroxide compound is a single metal compound (also referred to as “mono metal compound”), herein presented by MᵢOₖ, MᵢOₖ(OH)ₜ and Mᵢ(OH)ₜ, respectively, wherein the indicators i and k, each independently, is an integer or a fraction in the range of from 1 to 8, and t is as defined above.

Exemplary single metal oxides include, but are not limited to, MnO₂, SnO₂, CeO₂, ZrO₂, CuO, TiO₂ and HfO₂. Exemplary single metal oxy-hydroxide compounds include, but are not limited to, AlO(OH) and GaO(OH). Exemplary single metal hydroxide compounds include, but are not limited to, In(OH)₃, Co(OH)₂, Ni(OH)₂, Al(OH)₃, Ga(OH)₃ or Sc(OH)₂.

In some embodiments, any of the metal oxide, metal oxy-hydroxide or metal hydroxide compound is a binary metal compound (i.e., comprising two different metal cations), herein presented by MᵢM′ⱼOₖ, MᵢM′ⱼOₖ(OH)ₜ and MᵢM′ⱼ(OH)ₜ, respectively, wherein the indicators I, j, k and t are as defined above.

Exemplary binary metal oxides include, but are not limited to, BaTiO₃, SrTiO₃, LiNbO₃, KNbO₃, LiTaO₃, NiNbO₃H, Fe₂O₃ with Cr(III) as dopant or TiᵢSnⱼOₖ, wherein and i and j, each independently, is an integer or a fraction in the range of from 1 to 20, and k is an integer or a fraction in the range of from 1 to 8, for example, from 1 to 3.

The nanoparticle core in a disclosed complex may comprise nanocrystals such as single crystals and/or polycrystals, or amorphous nanoparticles.

In some embodiments, at least one metal cation in the POM ligand is bound in an “out-of-pocket” fashion, wherein, optionally, the out-of-pocket metal cation forms oxide and/or hydroxide linkages to one or more metal cations on the NP surface.

POM-NP complexes described in the present dislosure include, for example, complexes wherein:
POM is a heteropolytungstate and NP comprises MnO₂;
POM is a heteropolytungstate and NP comprises SnO₂;
POM is a hexaniobate and NP comprises SnO₂;
POM is a heteropolytungstate and NP comprises CeO₂;
POM is a heteropolytungstate and NP comprises ZrO₂;
POM is a heteropolytungstate and NP comprises HfO₂;
POM is a hexaniobate and NP comprises CuO;
POM is a hexaniobate and NP comprises TiO₂;
POM is a hexaniobate and NP comprises Co(OH)₂;
POM is a hexaniobate and NP comprises NiNbO₃H;
POM is a heteropolytungstate and NP comprises CrFeO₃;
POM is a hexaniobate and NP comprises TiᵢSnⱼOₖ, wherein i, j and k, each vary from 5 to 100% of the metal-cation composition; or
POM is a heteropolytungstate and NP comprises Fe₂O₃ with Cr(III) as dopant.

In any of the complexes disclosed herein, the POM may have a Lindqvist, Keggin, Anderson or Wells-Dawson (WD) structure. For example, POM may be aKeggin-type heteropolyoxoniobatem such as, but not limited to, [PNb₁₂O₄₀]¹⁵⁻.

In some embodiments, the POM is a substituted POM (also referred to herein as “defect POM”), for example, a substituted Wells-Dawson (WD) cluster anion. The substituent may a metal hydroxide, for example, In(III)OH. An exemplary mono-defect or substituted WD cluster anion disclosed herein is [{α₂-P₂W₁₇O₆₁}(In(III)OH)]⁸⁻.

Specific POM-NP complexes disclosed herein include:
[α-PW₁₁O₃₉]⁷⁻-complexed SnO₂ nanoparticles (Complex 1);
[Nb₆O₁₉]⁸⁻-complexed SnO₂ nanoparticles (Complex 2);
[Nb₆O₁₉]⁸⁻-complexed Sn_{0.5}Ti_{0.5}O₂ nanoparticles (Complex 3);
[Nb₆O₁₉]⁸⁻-complexed Sn_{0.25}Ti_{0.75}O₂ nanoparticles (Complex 4);
[Nb₆O₁₉]⁸⁻-complexed Sn_{0.13}Ti_{0.87}O₂ nanoparticles (Complex 5);
[Nb₆O₁₉]⁸⁻-complexed TiO₂ nanoparticles (Complex 6);
[α-PW₁₁O₃₉]⁷⁻-complexed Sn_{0.13}Ti_{0.87}O₂ nanoparticles (Complex 8);
[α-AlCr(V)W₁₁O₄₀]⁶⁻-complexed ε-MnO₂ nanoparticles (Complex 11);
[α-PW₁₁O₃₉]⁷⁻-complexed CeO₂ nanoparticles (Complex 12);
[α-PW₁₁O₃₉]⁷⁻-complexed ZrO₂ nanoparticles (Complex 13);
[α-PW11O39]⁷⁻-complexed HfO₂ nanoparticles (Complex 14);
[Nb₆O₁₉]⁸⁻-complexed Co(OH)₂ nanoparticles (Complex 15);
[Nb₆O₁₉]⁸⁻-complexed CuO nanoparticles (Complex 16);
[Nb₆O₁₉]⁸⁻-complexed Ni_{0.3}Nb_{0.2}OH_{0.4} nanoparticles (Complex 17);
[α-PW₁₁O₃₉]⁷⁻ complexed CrFe₂O₃ nanoparticles (Complex 18);
Na₈[{α₂-P₂W₁₇O₆₁}(In(III)OH)]-complexed In(OH)₃ nanoparticles (Complex 19);
Cu₄[{α₂-P₂W₁₇O₆₁}(In(III)OH)]-complexed In(OH)₃ nanoparticles (Complex 20);
[{α₂-AlW₁₁O₃₉}In(III)OH)]-complexed In(OH)₃ nanoparticles (Complex 21); and
[α-PW₁₁O₃₉]⁷⁻-complexed 6-line ferrihydrite nanocrystals (Complex 22).

In Complexes 19 and 20, [{α₂-P₂W₁₇O₆₁}In³⁺OH)]⁸⁻ is bound to In(III) cations of the In(OH₃) nanocrystals via OH ligand on the POM.

The POM-NP complexes disclosed herein address various unmet needs such as improved catalysts and stabilization of metastable phase of crystals.

The POM ligands described herein are complexed to the NP core in alternative ways, which substantially differ from POM binding in known complexes. For example, the POM ligand is covalently attached to the metal oxide or metal hydroxide core, thereby providing inherent thermodynamic stability in water. For example, POM-NP complexes described herein are impressively stable in water at pH from 2 to 8, the stability being reflected as stability to oxidation, hydrolysis, aggregation and/or ligand exchange. For example, POM complexed hematite, or metastable ferrihydrite are rendered water-soluble and substitutionally inert, as well as inherently stable to oxidation and hydrolysis due to covalent bonding of the POM.

As a result of this inherent stability, the POM-NP structures of the present disclosure are particularly useful as soluble water-oxidation catalysts (WOCs), such as in visible-light driven catalysis. Importantly, POM complexes disclosed herein can be operated for at least 7 days with no decrease in activity.

Some POM-NP complexes disclosed herein comprise metal cations larger than ever used thus far, for example, larger than Ti(IV) and Fe(III). These complexes may be, for example, “out-of-pocket” tetradentate coordinated POM complexes, wherein at least one metal cation of the POM is too large to fit into the internal pentacoordinate “pocket”. As such, the large metal cation remains farther from the center of the POM cluster and is bound, e.g., by four oxygen atoms in a tetra-coordinated “out-of-pocket” fashion to the POM and, optionally, by one or more oxide and/or hydroxide linkages to NP surfaces metals. These “out-of-pocket” tetradentate coordinated POM complexes feature unexpected stability.

In a further aspect, the present disclosure relates to an aqueous solution comprising a POM-NP complex as described herein, in a concentration in a range of from 8% to 20% w/v.

### BRIEF DESCRIPTION OF THE DRAWINGS

FIGS. 1A-1D are ball-and-stick and polyhedral views of three heteropolyanions POMs: Keggin (1A), Lindqvist (an isopolyanion POM) (1B), Anderson (1C) and Wells-Dawson (1D). Dark grey spheres are metal centers, whereas light ones are oxygens. Black spheres (and the homologous dark polyhedra) contain the X heteroatom. 1B-1D are taken from: Introduction to Polyoxometalates and Scope of the Work, and from_Herrmann et alo., Chem. Commun., 2015, 51, 13702-13705);

FIG. 2 are powder X-ray diffraction (PXRD) spectra of 4 exemplary POM complexes (Complexes 1, 2, 3, and 5). Calculated spectra of rutile TiO₂ and its isomorphous structure, cassiterite SnO₂, are shown;

FIGS. 3A-3B are cryo-transmission electron microscopy (TEM) image (3A) and energy Dispersive X-ray Spectroscopy (EDS) image (3B) of purified sample of [α-PW₁₁O₃₉]⁷⁻-complexed SnO₂ nanocrystals (NCs) (Complex 1);

FIG. 4 is a cryo-TEM image of [Nb₆O₁₉]⁸⁻-complexed Sn_{0.5}Ti_{0.5}O₂ NCs (Complex 3);

FIG. 5 is a Powder X-ray Diffraction (PXRD) spectrum of Nb₆O₁₉]⁸⁻-complexed TiO₂ NCs (Complex 7). Calculated spectra of rutile TiO₂ and anatase TiO₂ are shown;

FIG. 6 is a Powder X-ray Diffraction (PXRD) spectrum of [α-PW₁₁O₃₉]⁷⁻-complexed Sn_{0.13}Ti_{0.87}O₂ (Complex 8). Calculated spectra of rutile TiO₂ and anatase TiO₂ are shown;

FIGS. 7A-7E are images showing the analysis results for [α-PW₁₁O₃₉]⁷⁻-complexed Sn_{0.13}Ti_{0.87}O₂ nanocrystals (Complex 8). (7A): cryo-TEM image, (7A), elemental mapping of Complex 8 using EDS in STEM mode, (7C-7E): elemental mapping of Complex 8 using EDS in STEM mode;

FIGS. 8A-8B are schematic illustrations of 9 POM spheres (102) packing and projections (104) on the surface of a spherical nanoparticle core (100), wherein the nanoparticle radius, R (106) is comparable to the POM radius, r_{POM}, (8A) or much larger than r_{POM} (8B);

FIG. 9 is a scheme showing the synthesis of [α-PW₁₁O₃₉]⁷⁻-complexed ZrO₂ nanoparticles (Complex 13);

FIGS. 10A-10F are analysis spectra and images of three “out-of-pocket” complexes of the POM heteropolytungstate (PW₁₁O₃₉⁷⁻) to Zr in 3 different modes: (i): the dimeric complexation of Zr(IV), [{α-PW₁₁O₃₉Zr(μ-OH)(H₂O)}₂]⁸⁻·7H₂O) (Zr₂:POM₂); (ii) the “sandwich” complexation of Zr(IV), [Zr(α-PW₁₁O₃₉)₂]¹⁰⁻·7H₂O (Zr:POM₂); and (iii) [α-PW₁₁O₃₉]⁷⁻-complexed ZrO₂ nanoparticles (Complex 13). (10A): ³¹P NMR spectra of Zr₂:POM₂ and Zr:POM₂. (10B): Fourier transform infrared (FTIR) spectra of Zr₂:POM₂ and Zr:POM₂. (10C): FTIR bands of Complex 13. (10D): dynamic light scattering (DLS) of Complex 13. (10E) and (10F): transmission electron microscopy (TEM) and cryo-TEM images of Complex 13, respectively;

FIGS. 11A-11C are spectra and graphs showing the UV absorbance of PW₁₁O₃₉⁷⁻-complexed ZrO₂ nanocrystals (NCs) (Complex 13) at varying UV irradiation times. (11A): UV-vis spectra of the irradiated POM (PW₁₁O₃₉⁷⁻) at the surface of the ZrO₂ NCs. (11B): change of absorbance maximum as a function of irradiation time;

FIGS. 12A-12B are photographs of Eppendorf tube taken after addition of CsCl to a [Nb₆O₁₉]⁸⁻-complexed Co(OH)₂ solution and centrifugation (11A), and after re-dissolution in pH 9 CsOH solution (11B);

FIGS. 13A-13D are images and a spectrum showing some characterizing properties of Complex 16 ([Nb₆O₁₉]⁸⁻-complexed CuO). (13A): Cryo-TEM image of a green solution of Complex 16. Upper inset: dynamic light scattering (DLS) of a clear aqueous solution of Complex 16. Lower-right inset: high-resolution TEM (HRTEM) image of CuO in Complex 16 showing (111) planes. (13B): rings from selected-area electron diffraction (SAED) of Complex 16 showing crystal planes matching monoclinic CuO. (13C): energy-dispersive X-ray (EDX) of a dried sample of Complex 16, from high-angle annular dark-field (HAADF) imaging, revealing abundant Cu and Nb (red and yellow, respectively). (13D): FTIR spectra of K₈Nb₆O₁₉ (grey curve) and Complex 16 (red curve);

FIG. 14 is a schematic presentation of the proposed binding and orientation of a [α₂-P₂W₁₇O₆₁]In(III)-μ-OH ligand at the surface of a 90% dzhalindite In(OH)₃ NC (Complex 19);

FIGS. 15A-15C are images characterizing the cubic dzhalindite In(OH)₃ phase in the cores of Na₈[{α₂-P₂W₁₇O₆₁}(In(III)OH)]-complexed In(OH)₃ nanoparticles (Complex 19). 15(A): TEM image of insoluble platelike In(OH)₃ NCs (after drying) obtained by the reaction of aqueous In(III) with 2.8 equiv of NaOH with no POM cluster anions present (scale bar=50 nm). (15B): rapidly acquired, high resultionTEM image of a purified sample of Complex 19, after drying. (scale bar=10 nm). (15C): magnification of the region indicated by a white square in FIG. 15B (scale bar=5 nm);

FIGS. 16A-16B are images showing the solution-state structure and elemental composition of Complex 19. (16A): Cryo-TEM image of Complex 19 in vitrified water. The presence of POM ligands is shown as dark objects of ca. 1-2 nm in size, on the particle surface. (16B): elemental mapping by energy dispersive X-ray spectroscopy (EDS) of Complex 19;

FIG. 17 is Fourier transform infrared (FTIR) spectra characterizing the WD POM ligands in Complex 19. Upper curve: spectrum of In(OH)₃ nanoplates (no POM ligands); middle curve: [α₂-P₂W₁₇O₆₁In(III)OH]⁸⁻; lower curve: Complex 19;

FIGS. 18A-18B show the production and obtainment of Cu₄[{α₂-P₂W₁₇O₆₁}(In(III)OH)]-complexed In(OH)₃ nanoparticles (Complex 20). 18(A): schematic illustration of quantitative replacement of 8 Na⁺ countercations of the surface-bound [α₂-P₂W₁₇O₆₁In(OH)]⁸⁻ by four Cu²⁺ cations to give the corresponding Complex 20. (18B): elemental mapping of Complex 20 by EDS (scale bars=500 nm);

FIG. 19 is a schematic illustration of of the electrochemical reduction of carbon dioxide and protons in the designed cell that consists of two sealed compartments separated by a thin Nafion membrane. The first compartment (on the right) contains a gas-diffusion layer (GDL) electrode, coated with Complex 20, as the working electrode and Ag/AgCl as the reference electrode. The second compartment (on the left) contains a platinum counter electrode;

FIG. 20 is differential pulse voltammetry (DPV) spectrum of Complex 20 deposited on a GDL electrode, showing three reversible redox waves corresponding to the W(VI)/W(V) couples observed in the DPV of reference Complex 19 (marked by arrows), and of the Cu(II)/Cu⁰ couple (ca. −0.1 V); and

FIG. 21 is a schematic illustration of the formation of POM-entrapped and fee 6-line ferrihydrite NCs. The lower image on the left side is a cryo-TEM image soluble β-FeOOH nanorods. Top pathway: growth of the ferrihydrite NCs and transformation thereof to α-Fe₂O₃ in absence of POM ligands. Nanorods of α-Fe₂O₃ are shown on top right cryo-TEM image. Bottom pathway: POM entrapment of ferrihydrite particles before reaching the critical radius of phase transformation to hematite. Bottom right image is a cryo-TEM image of the POM-complexed ferrihydrite (Complex 22). POMs at the surface of a NC are indicated by red arrows. Scale bars: black w/white border=10 nm; white w/black border=50 nm. Color code: Fe(III)-centered polyhedra are orange (or green, for ease of layer packing distinction), W(VI)-centered octahedra are yellow, P(V)-centered tetrahedra are in red.

### DETAILED DESCRIPTION

The present disclosure relates to complexes of various polyoxometalates (POMs) and metal nuclears such as, but not limited to, metal oxide, metal oxy-hydroxide and/or metal hydroxide nanocrystals, and use thereof.

The present inventors previously discovered that certain POMs such as the hexaniobate cluster-anion complexed to CuO nanocrystals (NCs) modified the catalytic activity of soluble CuO NCs by trapping small quantum-confined crystals, whose small size impart to them an unprecedented ability to catalyze visible-light driven water oxidation in the absence of added photosensitizers. Hexaniobate was stable at the elevated pH values needed to form CuO in water.

A polyoxometalate is a polyatomic ion, usually an anion, that consists of three or more transition metal oxyanions linked together by shared oxygen atoms to form closed 3-dimensional frameworks or cages. A negatively charged POM is also referred to herein as “cluster-anion”. The metal atoms are usually group 6 (Mo, W) or, less commonly, group 5 (V, Nb, Ta) transition metals in their high oxidation states. In general, POMs comprise MO_{b} units, where M is a metal ion and b indicates the coordination number of M. Usually, b=6, although it can be 4, 5 or 7, or higher. A basic POM framework is designated herein “MₚO_{y}”, wherein p and y are the relative amounts of metal and oxygen ions, respectively. Apart from M and O, other elements, herein labelled as X, can be part of the POM framework. As a rule, the X elements are 4-fold- or 6-fold-coordinated and lie in the center of the MₚO_{y} shell or cage. Depending on whether X is present or not, two types of POM species may be distinguished, based on a purely structural criterion:
Isopolyanions (IPAs; also referred to as iso-polyoxometalates), designated herein as [MₚO_{y}]ⁿ⁻; and
Heteropolyanions (HPAs; also referred to as heteropolymetalates), designated herein as [X_{z}MₚO_{y}]ⁿ⁻, wherein z<p denoting the relative amount of X in the POM.

Many exceptions to these two types of POMs exist.

X is also referred to herein, interchangeably, as a “primary heteroatom”, “core heteroatom” or “central heteroatom”. In general, any element can be X in a POM cluster since there are no strict physical requirements for this position. Exemplary X includes, but is not limited to, phosphate, silicate, etc.

The metal atom M is referred to herein, interchangeably, as “secondary”, “peripheral” or “addenda” atom. Herein, M represents one type of metal or 2 or more different metals. Usually, only certain metals are typically found in such compounds. In anions, in which more than one type of addenda atom (M) is present in the framework, the molecule is known as a mixed-addenda cluster. Despite the simplicity of the IPAs and HPAs formulas above, the chemical structure of a cluster can be highly complexed, with various metals taking part in the structure.

The typical framework building blocks (MO_{b}) are polyhedral units, with typically 6-coordinate metal centers (MO₆) forming an approximate octahedron (i.e., pseudo-octahedral symmetry). These octahedra are usually packed to form countless shaped cages. They are joined to each other in accordance with a few simple rules, such that the cluster (or cage) as a whole is built by edge and/or corner sharing MO₆ octahedra. The most stable POMs are formed by corner and edge sharing octahedra, in which the M^{b+} ions are far enough from each other, and their mutual repulsion is modest. The coordination number of the oxide ligands varies according to their location in the cage. Surface oxides tend to be terminal or doubly bridging (two coordinate) oxo ligands. Interior oxides are typically triply bridging (three coordinate) or even six coordinated.

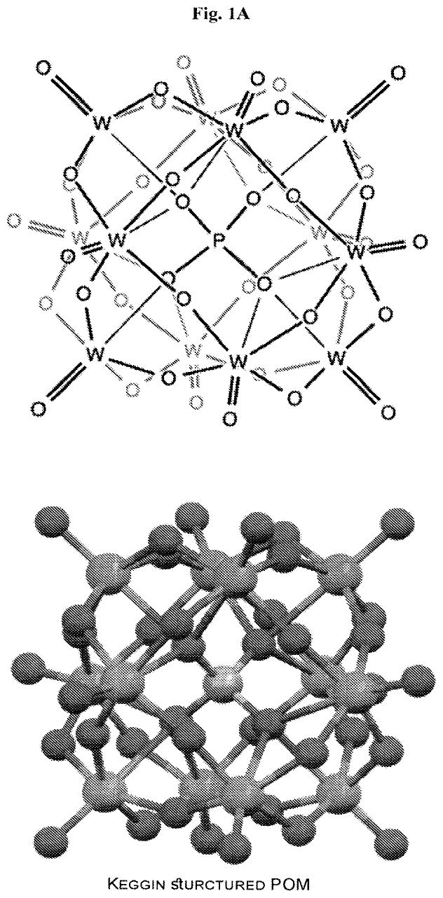

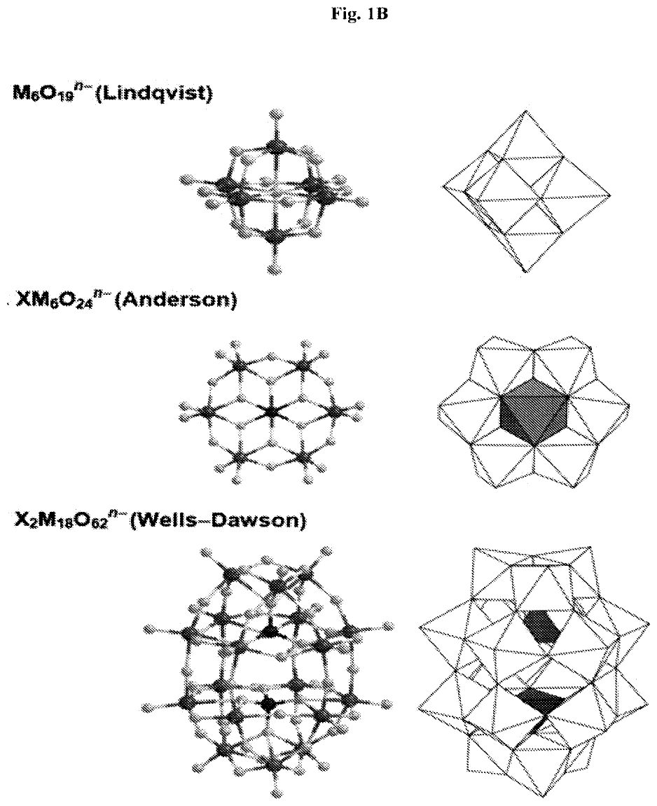

Recurring structural motifs determine the POM's classification: isopolyanions (IPAs; [MₚO_{y}]ⁿ⁻) feature octahedral metal centers, whereas heteropolyanions ([X_{z}MₚO_{y}]ⁿ⁻) form distinct structures because the core heteroatom at the center is usually tetrahedrally coordinated by four oxide ligands. The Lindqvist structure exemplifies an IPA, whereas Keggin, Anderson [XM₆O₂₄]ⁿ⁻ and Wells-Dawson (WD) [X₂M₁₈O₆₂]ⁿ⁻ structures are common motifs for heteropolyanions (FIGS. 1A-1D), with the coordination numbers of the central X cations varying between these three general classes.

The term “Keggin structure”, as referred to herein, is the structural form of α-Keggin anions, which are represented herein by the general formula [XM₁₂O₄₀]ⁿ⁻, where the heteroatom X is actually a heterocaction X^{m+} (e.g., P⁵⁺, Si⁴⁺, or B³⁺, while many other cations are optional), and M, the addendum atom is, e.g., molybdenum (Mo), Vanadium (V) or tungsten (W). M can denote 2 or more different metal atoms within the same POM, e.g., W and Ti. The Keggin structure self-assembles in acidic aqueous solution and is noted for its stability in catalysis at suitable pH values. The structure has a full tetrahedral symmetry and is composed of one core heteroatom, X^{m+}, surrounded by four oxygen atoms to form a tetrahedron. The core heteroatom and it's four oxide ligands, i.e., [X^{m}O₄]^{(8-m)-} is located centrally and caged by 12 pseudo-octahedral MO₆ units linked to one another by the neighboring oxygen atoms. There are a total of 24 bridging oxygen atoms that link the 12 addenda atoms. The metal centers in the 12 pseudo-octahedra are arranged on a sphere as four distinct triads (i.e., M₃O₁₃ units) almost equidistant from each other, which account for the overall tetrahedral symmetry of the complete structure. The bond length between atoms varies depending on the core heteroatom and the addenda metal atoms. This structure allows the molecule to be hydrated and then dehydrated and to be reversibly reduced and reoxidized without significant structural changes.

Including the original Keggin structure, there are 5 isomers, designated by the prefixes α, β, γ, δ and ε. The generally most-stable Keggin structure is designated α. These isomers arise due to different rotational orientations of the M₃O₁₃ units, which lower the symmetry of the overall structure. An exemplary Keggin structured POM is shown in FIG. 1A.

In the heteropolyanion Anderson [XM₆O₂₄]ⁿ⁻, the core heteroatom X is surrounded by six oxo ligands in a pseudo-octahedral symmetry whereas, in Wells-Dawson [X₂M₁₈O₆₂]ⁿ⁻, two heteroatoms X are tetrahedrally coordinated (see Background art schemes if FIGS. 1C, 1D, respectively). In the case of Wells-Dawson structures [X₂M₁₇O₆₂]ⁿ⁻, in which a single M atom (e.g., W) is removed to generate a metal binding site, the location of the vacancy is indicated by the designations “α₂” if the defect lies in one of the two triads at the “top” or “bottom” of the cluster, or “α₁” if located in one of the two central belts of originally six M cations each.

Lindqvist metal oxide clusters contain two structurally different atoms: M and O, and are represented as [M₆O₁₉]ⁿ⁻, as illustrated in FIG. 1B. However, the central atom (an oxygen) is chemically very different from the external ones since it is surrounded by six cations.

Clusters (POMs) with p-block elements (X=P, Si, Al, Ga, Ge . . . ), transition metal elements (X=Fe(II/III), Co(I/II), Ni(II/IV), Zn(II) . . . ), and even two H⁺ have been synthesized. The heteroatom position can be either tetrahedrally coordinated (as in Keggin and Wells-Dawson anions) or octahedrally coordinated (as in the Anderson structure).

A bridging ligand is a ligand that connects two or more atoms. In the context of the present disclosure, the ligand in a POM is an atom or group of atoms which connect two or more metal ions. The bridging ligand is labeled by the Greek letter μ with a subscript number, which is the number of metals bound to the bridging ligand. The symbol μ₂ (i.e., a ligand binding two Ms) is often denoted simply as μ. In the context of POMs described herein, the bridging ligand may be oxygen, also referred to herein as a “μ-oxo” ligand, which can bridge two Ms (μ₂-O or μ-O) or more than two metal cations (e.g., μ₃-O, μ₄-O). The bridging ligand may also be hydroxy group, also referred to herein as a “μ-OH” ligand, that bridges, e.g., two metal cations.

The bridged metal cations may belong to the POM and/or to the complexed or ligated nanoparticle (e.g., a metal oxide nanocrystal).

Polyoxometalates typically exhibit coordinate metal-oxo bonds of different multiplicity and strength. In a typical POM such as the Keggin structure [PW₁₂O₄₀]³⁻ (i.e., X=P, M=W), each addendum atom connects to a single terminal oxo ligand, four bridging μ₂-O ligands and one bridging μ₃-O which connects also to the central heteroatom (P).

The term “nanoparticles” refers to individual entities or articles having a structure in which at least one dimension is on a nanometer scale (i.e., from 1 nm up to 1 micro m). The term “nanoparticles” includes, for example, quantum dots, spherical and pseudo-spherical particles, faceted particles, nanorods, nanowires, anisotropic particles, and the like. Further, the term “nanoparticles” includes single crystal nanoparticles (i.e., nanocrystals), polycrystalline nanoparticles, and amorphous nanoparticles. In the context of the present disclosure, a nanoparticle (NP) forms the core of the POM complexes and is a cluster of multiple metal oxide, oxy-hydroxide and/or metal hydroxide compounds.

Embodiments described herein pertain, but are not exclusive, to single crystal, polycrystalline and/or amorphous nanoparticles formed from a plurality of multiple metal oxide, oxy-hydroxide and/or metal hydroxide particulate matter. For example, the NP may be a nanocrystal (single crystal), namely, a crystalline particle with at least one dimension measuring less than 1000 nanometers (nm).

The terms “coated nanoparticle” and “complexed nanoparticle”, as used to herein, are interchangeable and refer to a structure comprising a core comprising at least one metal oxide, oxy-hydroxide and/or metal hydroxide NP, e.g., as defined herein, and an overcoating comprising polyoxometalate structures complexed to this core. The metal oxide, oxy-hydroxide and/or metal hydroxide nanoparticle cores ligated by POMs may be nanocrystals (NCs).

In a population of coated nanoparticles, each nanoparticle is a complexed core as defined herein, overcoated with POM ligands. A monodisperse, as referred to herein, is a population of nanoparticles with variance of particle size smaller than 30%.

In one aspect, the present disclosure relates to POM-complexed NPs represented, for brevity, by a general formula (I):

(Qₗ[i-POM])ₘ[NPᵣ],
wherein Qₗ[i-POM] designates a polyoxometalate, e.g., tungsten- or niobium-based cluster-anion, whose charge is counter-balanced by “l” alkali-metal, H or organic cations Q; l, the number of Q counter-cations, corresponds to the charge of the POM (designated herein as “n−”), and is most commonly an integer of 1 to 40.

The indicator m is the number of POMs bound to an individual nanoparticle (NP) and may be any number between 1 to 10,000, for example, between 1 to 6000.

“i” designates a specific POM isomer, if known. Otherwise, i is absent.

The nanoparticle NP may be a cluster of one or more empirical units, herein sometimes simply referred to as “units”, selected from metal-oxide, metal oxyhydroxide and/or a metal hydroxide. For example, NP may comprise multiple units of CuO, FeO(OH) or In(OH)₃, respectively. The number of such empirical units in a NP are denoted herein by the indicator “r”, where r can range from less than 50 to 6,000,000 or larger. For example, r may be between 75 to 6,000,000.

The POM complexes themselves, each with a specific NP core, can aggregate into amorphous or crystalline supra-assemblies comprising numerous complexed NPs, for example, from 1 to 100,000 complexes.

In some embodiments, POM is represented by the Formula (Ia):

[X_{z}MₚC_{d}O_{y}]ⁿ⁻
wherein X is H or at least one heteroatom such as, but not limited to, P, Ar, Sb, S, Si, Ge, B, or at least one metal atom such as, but not limited to, Be, Mg, Ca, Sr, Mn, Fe, Co, Ni, Cu, Zn, Al, or Ga.

M is at least one transition metal cation in various oxidation states, optionally, in a high oxidation state such as, but not limited to, W, Nb, V, Ta, Cr, Ti, Zr, Mn, Re, Pd, Hf, Cu, Ru, Mo, Rh, Pt, Fe, Ag, Au, Zn, Cd, and/or a main-group metal cation in various oxidation states such as, but not limited to, Al, Ga, In, Sn and/or Pb. M, also referred to herein as addendum metal atom, accounts both for one type of metal as well as for two or more different metal atoms within the same POM, e.g., W and Ti, or W and In.

In some embodiments, M in POM is V, Nd, Mo and/or W, with cations of other metals being relatively fewer in number than the main elements.

C is H, OH, H₂O, or an organic moiety such as a lower alkyl, lower hydroxyalkyl, lower silylalkyl, lower silylalkoxy and/or carboxylate.

Optionally, C is linked directly to M or O of the POM cluster.

z is 0 to 100; p is 6 to 250; d is 6 to 100; and y is 15 to 800. The indicators z, p, d and y represent the relative amount of X, M, C and O in the POM, respectively, and may be any integer or a fraction in the indicated ranges.

In some embodiments, C is OH and the POM is referred to herein as a partially protonated POM and presented as [X_{z}MₚO_{y}OH_{d}]ⁿ⁻, wherein d is the relative amount of OH groups.

H₂O, in the context of the present disclosure, may also be denoted as OH₂.

The term “lower alkyl”, as used herein, refers to a saturated, branched or unbranched (straight chain) hydrocarbyl group with 1 to 6 carbon (C) atoms (herein also denoted as C1-C6 alkyl) such as, but not limited methyl (C1 alkyl), ethyl (C2 alkyl), C3 alkyl such as n-propyl or iso-propyl, C4 alkyl such as butyl, iso-butyl, sec-butyl or tert-butyl, C5 alkyl such as n-pentyl, iso-pentyl, neo-pentyl or tert-pentyl, C6 alkyl such as n-hexyl, and iso-hexyl.

In some embodiments, the lower alkyl is a C1-C3 alkyl.

The terms “lower hydroxyalkyl” and “alkoxy”, as used herein, are interchangeable and refer to a lower alkyl, as defined herein, substituted with one or two hydroxy groups (OH), provided that if two hydroxy groups are present they are not both on the same carbon atom. Representative examples include, but are not limited to, hydroxymethyl (also denoted herein as “HO—C1 alkyl”), 2-hydroxyethyl (HO—C2 alkyl), 2-hydroxypropyl (HO—C3 alkyl), 3-hydroxypropyl (HO—C3 alkyl), I-(hydroxymethyl)-2-methylpropyl ((HO)₂—C5 alkyl), 2-hydroxybutyl (HO—C4 alkyl), 3-hydroxybutyl (HO—C4 alkyl), 4-hydroxybutyl, 2,3-dihydroxypropyl, 1-(hydroxymethyl)-2-hydroxyethyl, 2,3-dihydroxybutyl, 3,4-dihydroxybutyl ((HO)₂—C4 alkyl) and 2-(hydroxymethyl)-3-hydroxypropyl ((HO)₂—C5 alkyl).

In some embodiments, the lower hydroxyalkyl is HO—C1 alkyl, HO—C2 alkyl and/or HO—C3 alkyl.

The term “lower silylalkyl”, as used herein, refers to the radical SiR₁R₂R₃ derived from silane (SiH₃), wherein the silicon atom Si is covalently bonded to one, two or three lower alkyl groups. Namely, R₁, R₂ and R₃, each independently is H or a lower alkyl a defined above. When one or more of R₁, R₂ and R₃ is an alkoxy, then the radical is referred to herein as “silylalkoxy”, wherein alkoxy is as defined herein.

The term “carboxylate”, interchangeable with “carboxylate ion”, as referred to herein is the conjugate base (RCO₂⁻) of a carboxylic acid (RCOOH or RCO₂H), wherein R is H or a lower alkyl as defined herein.

In some embodiments, the NP comprises a plurality of metal oxide, optionally particulate, compounds, each having the empirical chemical formula represented herein by the Formula (Ib):

MᵢM′ⱼM″_{f}Oₖ,
wherein M, M′ and M″, each independently, is a metal cation;
i, j, f, each independently, is 0, an integer or a fraction in the range of from 1 to 20, provided that at least on of i, j or f is not 0. The indicators i, j and f refer to the relative amounts or relative quantities of each metal cation and can have any value in the range of from 0 to 20, for example, a value in the range of 1 to 8, such as, for example, 0.1, 0.5, 0.75, 1, 1.5, 2, 2.6, 3, 3.5, 4, 4.75, 5, 6, 7 or 8. The NP may comprise only one type of metal cation, e.g., M, in which case j and f are zero.
k indicates the relative amount/quantity of oxygen ions. k may be an integer or a fraction in the range of from 1 to 20. For example, an integer or a fraction in the range of from 1 to 8 or from 1 to 6, e.g., 0.25, 0.75, 0.86, 0.93, 1.3, 2, 3.5, 4, 5, 5.5, or 6.

The terms “relative amount” and “relative quantity”, as used herein, are interchangeable and indicate how much there is of a given element, e.g., M, M′, M″, O relative to the other elements in the empirical chemical formula. These terms also refer to the proportion, ratio, fraction, relative occurrence or abundance of each element in the empirical chemical formula.

The terms “empirical chemical formula”, “empirical chemical unit” and “empirical unit”, as used herein, are interchangeable and represent the simplest whole-number (i.e., an integer) and/or fractional number ratio of various atoms present in a compound. This is the chemical formula of a compound that gives the proportions (ratios) of the elements present in the compound but not the actual numbers or arrangement of atoms. This would be the lowest whole/fractional number ratio of the elements in the compound.

Each NP is comprised of r MᵢM′ⱼM″_{f}Oₖ empirical units. Namely, a metal oxide NP, as a whole entity, is designated herein as:

[MᵢM′ⱼM″_{f}Oₖ]ᵣ,
wherein r may be any number from 50 to 6,000,000.

The number or amount of POMs bound to a single NP,m, may be between 1 to 10,000. m increases according to increase in r as a function of crystal morphology.

In some embodiments, m is any number from 2 to 1000.

In some embodiments, r is any number from 100 to 6000.

In some embodiments, the nanoparticle is a nanocrystal (NC).

Organic solvent soluble POM-complexed metal-oxide NCs were prepared by the present inventors, by partially or completely replacing alkali-metal POM counter cations by organic cations or protons. This synthesis route is not known in the art.

In some embodiments, the NP comprises a plurality of metal oxy-hydroxide, optionally particulate, compounds, each having the empirical chemical formula represented herein by the Formula (Ic):

MᵢM′ⱼM″_{f}Oₖ(OH)ₜ,
wherein M, M′ and M″, each independently, is a metal cation;
i, j, f, indicating the relative amounts or relative quantities of M, M′ and M″, respectively, each independently, is 0, an integer or a fraction in the range of from 1 to 20, provided that at least on of i, j or f is not 0. Each of i, j and f may have a value in the range of 1 to 8, such as, for example, 0.1, 0.5, 0.75, 1, 1.5, 2, 2.6, 3, 3.5, 4, 4.75, 5, 6, 7 or 8. The NP may comprise only one type of metal cation, e.g., M, in which case j and f are zero. Alternatively, the NP may comprise, in which case f is zero.
k, indicating the relative amount/quantity of oxygen ions, may be an integer or a fraction in the range of from 1 to 20. For example, an integer or a fraction in the range of from 1 to 8 or from 1 to 6, e.g., 0.25, 0.75, 0.86, 0.93, 1.3, 2, 3.5, 4, 5, 5.5, or 6.
t is 0, an integer or a fraction in the range of from 1 to 8. For example, 0.1, 0.13, 0.4, 0.75, 1, 1.3, 1.5, 1.85, 2, 2.03, 2.8, 3.6, 4.5, 5, 5.75, 6, 6.5, 7, 7.32, 7.75 or 8.

With k contributing a charge of (−2) and t contributing a (−1) charge, these indicators must sum to the total positive charge of the metal cations, adjusted for relative abundance or occurrence in the empirical unit.

Each NP is comprised of r empirical units of MᵢM′ⱼM″_{f}Oₖ(OH)ₜ. Namely, a metal oxide NP, as a whole entity, is designated herein as:

[MᵢM′ⱼM″_{f}Oₖ(OH)ₜ]ᵣ,
wherein r may be any number from 50 to 6,000,000.

The number or amount of POMs bound to a single NP, m, may be between 1 to 10,000. m increases according to increase in r as a function of crystal morphology.

In some embodiments, m is any number from 2 to 1000.

In some embodiments, r is any number from 100 to 6000.

In some embodiments, the nanoparticle is a nanocrystal (NC).

In some embodiments, the NP comprises a plurality of metal hydroxide, optionally particulate, compounds, each having the empirical chemical formula represented herein by the formula (Id):

MᵢM′ⱼM″_{f}(OH)ₜ,
wherein M, M′ and M″, each independently, is a metal cation;
i, j, and f, each independently, is 0, an integer or a fraction in the range of from 1 to 20, provided that at least one of i, j or f is not 0. For example, the indicators i, j and f may have any value in the range of 1 to 8, for example, 0.13, 0.15, 0.2, 0.3, 0.45, 0.5, 0.65, 1, 1.5, 1.8, 2, 2.3, 2.4, 3, 3.75, 3.85, 4, 4.2, 4.5, 4.75, 5, 5.2, 5.8, 6, 6.2, 6.75, 7, 7.45, 7.65, or 8.
t is to the relative amount of hydroxy groups and is an integer or a fraction in the range of 1 to 20. For example, t is an integer or a fraction in the range of from 1 to 6 or from 1 to 3, e.g., 0.15, 0.18, 0.2, 0.26, 0.3.0.35, 0.37, 0.4, 0.45, 0.5.0.57, 0.6, 0.63, 0.68, 0.7, 0.75, 0.8, 0.84, 0.89, 0.9, 0.95, 1, 1.3, 1.6, 1.85, 2, 2.35, 2.68 or 3.

With each OH group contributing a (−1) charge, t must account to the total positive charge of the metal cations, adjusted for relative abundance.

POM-complexed metal ions that form stable μ-OH linkages to metal hydroxide NPs are disclosed herein for the first time.

In some embodiments, the nanoparticle is a NC.

Exemplary metal hydroxide NCs include In(OH)₃, Co(OH)₂, Ni(OH)₂, Al(OH)₃, Ga(OH)₃, Sc(OH)₂ and others comprised of main group or transition-metal cations.

Each NP is comprised of r empirical units of MᵢM′ⱼ(OH)ₜ. Namely, a metal hydroxide NP, e.g., a nanocrystal, as a whole entity, is designated herein as:

[MᵢM′ⱼM″_{f}OH)ₜ]ᵣ,

wherein r may be any number from 75 to 6,000,000, including integers and fractions.

m, the number of POMs bound to a single NP, may be between 1 to 10000. m increases according to increase in r as a function of crystal morphology.

In some embodiments, m is any number from 2 to 1000.

In some embodiments, r is any number from 100 to 6000.

Solvothermal methods, such as those used for the fabrication of metal oxides, have led to remarkable control over the sizes, morphologies, and phases of metal oxide nanocrystals. By contrast, no general approaches provide access to soluble metal hydroxide analogues. At the elevated temperatures used in solvothermal synthesis, metal hydroxides are typically unstable with respect to their dehydrative conversion to oxides, and in water, apart from in limited cases, they typically form either hydrated gels or insoluble nanosized or micron-sized crystals. At the same time, slurries of insoluble crystalline metal hydroxides catalyze organic transformations and photochemical processes and, when deposited onto other materials, serve as precursors to the oxide layers of functional multicomponent devices. In this context, the development of methods for the preparation of stable, water-soluble complexes of metal hydroxide NPs is critical for obtaining more effective catalysts for homogeneous-phase transformations and, more generally, could provide versatile modular precursors for the reproducible fabrication of functional multicomponent materials.

Water-soluble POM complexes of nanocrystals comprising metal-hydroxide (for simplicity, referred to herein as “metal hydroxide NCs”), were prepared by the present inventors, using novel synthesis approaches (See Example 22 herein). In some embodiments, the POM metal ions form stable μ-OH linkages (bridges) to the metal-hydroxide NCs.

In some embodiments, substituted POMs are ligands for metal hydroxide NPs. For example, when the POM is In(III)(OH)-substituted monodefect WD cluster-anion, it may serve as ligand that overcoats In(OH)₃ NCs so as to form stable, water soluble complexes. In some embodiments, the complexed or overcoated metal hydroxy core, e.g., In(OH)₃, may be platelike, cubic-phase (dzhalindite) In(OH)₃ NCs. Dzhalindite is a rare indium hydroxide mineral having yellow-brown color and chemical formula In(OH)₃, discovered in Siberia. The crystal system is isometric, i.e., characterized by three equal axes at right angles.

As described in the Examples section herein, facilitated by the water solubility of the POM-metal hydroxide NCs complex, counter-cation exchange was used by the present inventors to stoichiometrically disperse ca. 1800 Cu²⁺ ions in an atomically homogeneous fashion around the surfaces of each NC core. The utility of this impregnation method was successfully illustrated by using the ion-exchanged material as an electrocatalyst that reduces CO₂ to CO, 15 times faster per mg of Cu than does a control complex. These findings point to polyoxometalate complexation as a promising method for stabilizing and solubilizing reactive d-, p- and f-block metal hydroxide nanoparticles and for enabling their utilization as versatile components in the fabrication of functional multi-component materials.

Any of the metal atoms, M, M′ and/or M″ of the nanoparticle may sometimes be presented as being part of the polyoxometalate. POMs complexed to NPs disclosed herein include complexes in which the metals of the NP are confined to the NP, and complexes in which at least one metal of the NP is shared with the POM.

M, M′ and M″, each independently, may be Li(I), Na(l), K(I), Ag(I), Ba(II), Cd(II), Ca(II), Fe(II), Fe(III), Sr(II), Ti(III), Ti(IV), Zr(IV), Nb(V), Nb(III), Hf(IV), Ta(V), Mn(III), Mn(IV), Mo(II), Mo(III), Mo(IV), Re(II), Re(III), Re(IV), Re(V), Re(VI), Re(VII), W(IV), W(V), V(II), V(III), V(IV), V(V), Cr(III), Cr(IV), Cr(V), Ru(II), Ru(III), Ru(IV), Ru(V), Co(II), Co(III), Rh(I), Rh(III), Ir(IV), Ni(II), Pt(II), Pt(IV), Pd(II), Pd(IV), Zn(II), Cu(I), Cu(II), Pb(II), Pb(IV), Al(II), Al(III), Ga(II), Ga(III), In(III), Sn(II), Sn(IV), Sc(II), Sc(III), Au(IV), Au(V), Au(VI) or Ce(IV). The number in brackets denotes the oxidation stats or the charge of the metal cation. For example, Al(III) is equivalent to Al³⁺, Re(IV) to Re⁴⁺, Nb(V) to Nb⁵⁺, Nb(III) to Nb³⁺, Hf(IV) to Hf⁴⁺, W(V) to W⁵⁺, W(IV) to W⁴⁺ and the like.

In some embodiments, contemplated complexes comprise NPs comprising metal ions in oxidative states which have not been previously disclosed or known such as, but not limited to, Ta(IV), Mn(III), Mn(IV), Cr(III), Cr(IV), Cr(V), Ru(II), Ru(III), Ru(IV), Ru(V), Co(II), Co(III), Rh(I), Rh(III), Ni(II), Zn(II), Cu(II), Al(III), Ga(III), In(III), Sn(II) or Sn(IV). At least some of these cations are substantially larger than cations employed in known POM-NP complexes.

The NP may comprise only one type of metal cation, e.g., only M, in which case j and f are zero. Alternatively, the NP may comprise two different metals, in which case j or f is zero. Such NP is termed herein “binary NP”. A binary, NP as referred to herein, may comprise a plurality of oxide empiric units MᵢM′ⱼOₖ, oxy-hydroxide empiric units MᵢMⱼOₖ(OH)ₜ and/or hydroxide empiric units M₁Mⱼ(OH)ₜ, where M and M′ are different cations, and I, j, k and t are as defined above.

Non-limiting examples of binary oxides NP contemplated by the present disclosure include BaTiO₃, SrTiO₃, KNbO₃, LiNbO₃ and LiTaO₃.

In some embodiments, the NP may comprise three different metals. Such NP is termed herein “ternary NP”. A ternary, NP as referred to herein, may comprise a plurality of oxide empiric units MᵢM′ⱼM_{f}Oₖ, oxy-hydroxide empiric units MᵢMⱼM_{f}Oₖ(OH)ₜ and/or hydroxide empiric units MᵢMⱼM_{f}(OH)ₜ, where M, M′ and M″ are different cations, and I, j, k, f and t are as defined above.

The binary and ternary NPs disclosed herein may comprise two or three different transition or main-group metal cations, or non-metal main-group cations, in addition to oxygen (O).

To be noted, the successful synthesis, isolation and stability of binary and/or ternary NPs contemplated herein, cannot be assumed or expected based on known metal oxide NCs comprising a single type of metal cation. The POM complexation of ternary NPs, e.g., NP comprising metal oxides MᵢM′ⱼM″_{f}Oₖ, is a small step from the corresponding binary NPs, which represent a large and unprecedented step from the POM complexation of single metal NPs such as those known in the art.

Any of the binary of ternary NPs may be doped. In analogy to semiconductors, dopants may be added to binary or ternary oxide NPs to alter their properties, e.g., their electric resistivity or conductivity.

In some embodiments, a binary NP, for example, a binary oxide NP (MᵢM′ⱼOₖ), is a “doped” metal oxide, wherein one of the two metal cations is dominant in relative quantity whereas the second metal cation is present in small amounts as a dopant or an “impurity”. In some embodiments, a ternary NP, for example, a ternary oxide NP (MᵢM′ⱼM_{f}Oₖ), is a “doped” metal oxide, wherein one of the three metal cations is present in small amounts relative to the other two metal cations.

The POM, in any of the complexes described herein may be a heteropolymetalate having Keggin, Anderson or Wells-Dawson (WD) structure.

In some embodiments, a defect form of the POM, herein also interchangeably referred to as “substituted POM”, “defect POM” or “vacant POM”, which is a multi-dentate cluster anion for binding single metals in vacancies therein that, in turn, are coordinated by oxide (μ-O) or hydroxide (μ-OH) bridges or linkages to metals at the surfaces of complexed NPs. A monodefect POM is one in which a single addendum atom, e.g., W, has been removed thereby forming a vacancy. This vacancy may then be occupied by a different metal cation. For example, a monovacant POM may house In³⁺ in the vacancy formed by removal of W⁴⁺. Non-limiting examples of monovacant heteropolytungstate POMs include [α-XⁿW₁₁O₃₉]⁽¹²⁻ⁿ⁾⁻, wherein Xⁿ=P⁵⁺, Si⁴⁺, Al³⁺, and a monovacant Wells-Dawson (WD) POM such as [α₂-P₂W₁₇O₆₁]¹⁰⁻.

In some embodiments, POM substituted by In(III)OH, binds to In(III) cations of complexed In(OH₃) NPs, optionally, via the OH ligand on the POM-complexed In(III)OH moiety.

In some embodiments, the substituted POM is In(III)OH-substituted monodefect WD cluster-anion, for example, [{α₂-P₂W₁₇O₆₁}In³⁺OH)]⁸⁻.

In defect WD POMs, the substituted In(III) ions are bound in a pentacoordinate “in-pocket” fashion within the defect site of the WD anions, and at neutral or slightly basic pH values, the OH⁻ anions occupying their sixth coordination site are available to serve as donor ligands for In(III) cations, e.g., at the In(OH)₃ NP surface.

The present inventors, synthetized, for the first time, the In(III)-substituted mono-defect WD polyoxometalate cluster anions, [{α₂-P₂W₁₇O₆₁}(In³⁺OH)]⁸⁻, that served as ligands for a stable, water-soluble complexes of In(OH)₃ NCs (herein designated Complex 19 and 20).

In some embodiments, a non-substituted POM ligand comprises the metal element niobate (Nb). Non-limiting examples of such POMs include salts of hexaniobate such as [Nb₆O₁₉]⁸⁻ and of Keggin-type heteropolyoxoniobates such as [PNb₁₂O₄₀]¹⁵⁻. To be noted, tungstate-containing POM ligands bind to the NP surface in a fashion which is impossible for polyniobate-containing ligands. Polyoxoniobate complexation to metal-oxides is not known even though the use of a polyoxoniobate to stabilize a solution of a binary metal oxide was reported in one instance in Llordés et al. 2013 (Llordés et al., Nature, 2013 500:323-326). However, the nature of the obtained complex was not determined or reported. Although determination of atomic connectivity between ligands and NP surfaces remains a general challenge, polyniobate clusters bind metal ions in molecular complexes via coordination by bridging oxo atoms of Nb-μ-O—Nb linkages or by terminal Nb═O ligands. Similar interactions may be involved in complexation of hexaniobate ligands to metal-oxide NPs.

Embodiments of the present disclosure relate to diversified combinations of POMs and NPs, which form novel complexes. In some exemplary embodiments, the POM comprises Nb or W and the NP comprises, e.g., MnO₂, SnO₂, CeO₂, ZrO₂, CuO, TiO₂, NiNbO₃H, HfO₂, CrFe₂O₃, Co(OH)₂ or TiᵢSnⱼOₖ, wherein i, j and k, each independently, may vary from 1 to 20.

In some embodiments, the complex is a heteropolytungstate POM-complexed MnO₂.

In some embodiments, the complex is a heteropolytungstate POM-complexed SnO₂. This complex is described in Example 1 herein.

In some embodiments, the complex is a hexaniobate POM-complexed SnO₂. This complex is described in Example 2 herein.

In some embodiments, the complex is a heteropolytungstate POM-complexed CeO₂.

In some embodiments, the complex is a heteropolytungstate POM-complexed ZrO₂.

In some embodiments, the complex is a heteropolytungstate POM-complexed HfO₂.

In some embodiments, the complex is a hexaniobate POM-complexed CuO.

In some embodiments, the complex is a hexaniobate POM-complexed TiO₂. This complex is described in Examples 6 and 7 herein.

In some embodiments, the complex is a hexaniobate POM-complexed Co(OH)₂.

In some embodiments, the complex is a hexaniobate POM-complexed NiNbO₃H.

In some embodiments, the complex is a heteropolytungstate POM-complexed CrFeO₃.

In some embodiments, the complex is a hexaniobate POM-complexed TiᵢSnⱼOₖ, wherein i, j and k represent the relative amounts of Ti, Sn and O respectively, as defined herein. Overall, the relative amount of each of Ti and Sn can vary from 5 to 100% of the metal-cation composition. The tuning of the different metals affords the obtention of different physical properties and has advantages over single metal oxide NPs. For example, changing the relative amounts of Ti and Sn in the NPs improves optical properties of the NPs. It also improves the charge separation and transfer, which could be helpful for photocatalysis, advanced oxidation processes, and gas sensing. These complexes are further described in Examples 3-5 herein.

In some embodiments, the complex is a heteropolytungstate-POM complexed Fe₂O₃ with Cr(III) as dopant.

In some embodiments, the metal cations in the NPs are complexed by the POM ligands in alternative ways compared to known complexes. For example, larger metal cations of the POM ligand are bound to the POM cluster and then to the NPs via a weaker, tetra-coordinated “out-of-pocket” fashion. Such larger metal cation include, e.g., Zr(IV), Hf(IV), Ag(I), Ag(III), Pd(II), Pd(IV), Pt(II), Pt(IV), Pb(II), Pb(IV), Cd(II) and Ce(IV). This mode of complexing is substantially different from known complexes in which the metal cations in the POM ligands are bound via a very thermodynamically favorable (strong and stable) pentacoordinated, “in-pocket” fashion. Cations larger than Ti(IV) and Fe(III), are too large to fit into the pentacoordinate “pocket” such as in known POM ligands, thus, they remain farther from the center of the POM cluster and are bound by four oxygen atoms in a tetra-coordinated “out-of-pocket” fashion. The stability of such “out-of-pocket” tetradentate coordinated POM complexes, involving large metal cations forming oxide linkages to NP surfaces metals, cannot be a priory assumed. In addition, the “out-of-pocket” coordinated metal cations can bind to one NP metal cation at metal-oxide surfaces via two μ-O linkages or bind via one μ-O linkage to more than one metal cation at the oxide surface.

Complexes of POMs and metal oxides NPs are known. For example, Keggin heteropolytunsgsto-phosphate cluster-anion and a Keggin heteropolytunsgsto-silicate cluster-anion complexed to 6 nm diameter anatase-TiO₂ NCs are disclosed in Raula et al., 2015 (Raula et al., Angew. Chem. Int. Ed. 2015, 54: 12416-12421). The first Keggin complex is presented herein as (α-Q₄[PTiW₁₁O₄₀])₅₅[(TiO₂)₁₈₀₀], comprising ca. 6 nm diameter anatase-TiO₂ core, overcoated by ca. 55 heteropolytungstate POMs designated as α-Q₅[PTiW₁₁O₄₀]. The counter-balancing cation Q may be an alkali-metal cation such as Li⁺ or Na⁺ to facilitate solubility in water, or an organic cation such as n-Bu₄N⁺ or n-Octyl₄N⁺ for organic-solvent-soluble complexes. The indicator number of Q counter-cation corresponds to the charge of the POM ligand after subtracting one unit of charge to adjust for sharing of one O²⁻ atom of the POM with a Ti(IV) atom at the surface of the TiO₂ NP core. The isomer α of the POM is known for these specific complexes, but often the specific isomer or mixtures of isomers at the surface of complexed NPs is undetermined.

The second POM complexed metal oxide NCs disclosed in Raula et al., is presented herein as (α-Q₅[SiTiW₁₁O₄₀])˜₅₅[(TiO₂)˜₁₈₀₀], wherein Q is Li⁺ or Na⁺. This complex was not thoroughly characterized, therefore, the number of POM ligands and TiO₂ units in each NC are estimates.

Further known POM-metal oxide NCs complexes are disclosed, e.g., in Chakraborty et al., 2018 (Chakraborty et al., Nature Comm. 2018, 4896), and in Chakraborty et al., 2019 (Chakraborty et al., Angew. Chem. Int. Ed. 2019, 58:6584-6589). These publications disclose the following four POM-complexed 3 nm diameter hematite-Fe₂O₃ NCs:
(1) (α-Q₅[PFeW₁₁O₄₀])₁₅[(Fe₂O₃)₅₅₀], wherein Q is Li⁺, Na⁺, n-Bu₄N⁺ or n-Octyl₄N⁺;
(2) (α-Q₆[SiFeW₁₁O₄₀])˜₁₅[(Fe₂O₃)˜₅₅₀], wherein Q is Li⁺, Na⁺ or K⁺;
(3) (Q₆[AlFeW₁₁O₄₀])˜₁₅[(Fe₂O₃)˜₅₅₀], wherein Q is Li⁺, Na⁺ or K⁺; and
(4) (Q₈[α₂-P₂FeW₁₇O₆₂])˜₁₅[(Fe₂O₃)˜₅₅₀], wherein Q is Li⁺, Na⁺ or K⁺.

Further known POM-metal oxide NCs complexes include two closely related POM-complexed 2.6 nm diameter γ-FeOOH (gamma iron oxyhydroxide) NCs, disclosed in Duan et al., 2021 (Duan, et al., ACS Catal., 2021, 11:11385-11395), namely:
(1) (α-Q₅[PFeW₁₁O₄₀])₆[(γ-FeOOH)₂₇₅], wherein Q is Li⁺, Na⁺, n-hexyl₄N⁺; and
(2) (Q₈[α₂-P₂FeW₁₇O₆₂])˜₁₅[(γ-FeOOH)˜₂₇₅], wherein Q is Li⁺ or Na⁺.

Llordés et al. 2013 (Llordés et al., Nature, 2013 500:323-326) discloses Sn-doped In₂O₃ (ITO) nanocrystals and POM [N(CH₃)₄]₆Nb₁₀O₂₈, which upon annealing, form the anionic [Nb₁₀O₂₈]⁶⁻ (the six [N(CH₃)₄] cations are decomposed).

Jing Huang et al., 2014 (Jing Huang et al., ACS Nano, 2014, 8(9): 9388-9402) discloses complexes of the POM ligands Na₃[PW₁₂O₄₀] and K₆[P₂W₁₈O₆₂] with the metal oxide NCs TiO₂, CoFe₂O₄ and ZnO.

Known POM-metal oxide and metal hydroxide NPs complexes, such as, but limited to, the complexes described herein, or described in the art (for example, in Talapin et al., 2014 (Talapin et al., ACS Nano, 2014, 8 (9): 9388-9402) and Llordés et al. 2013 (Llordés et al., Nature, 2013 500:323-326)), are excluded from the scope of the present disclosure.

The stability of known complexes, such as the POM-complexed TiO₂ and Fe₂O₃ NPs described above, parallels the stability of corresponding molecular complexes of Ti and Fe. As such, the coordinative bonds that stabilize POM-complexed Ti and Fe oxides are effectively identical to those found in smaller molecular complexes. Therefore, it is not surprising that analogous coordinative bonds stabilize POM-complexed metal-oxide NCs. That is not the case, however, for most other POM-complexed NCs, whose coordinative bonds, critical to stabilizing the complete structures, have no precedent in molecular complexes.

The term “molecular complex”, as used herein, refers to non-covalent associations between bound molecules. In other words, a molecular complex is a molecular entity formed by loose association involving two or more component molecular entities (ionic or uncharged), or the corresponding chemical species. The bonding between the components is normally weaker than in a covalent bond.

Some POM-NP complexes disclosed herein are held by covalent bonds. There is no molecular precedent for coordinative bonds responsible for formation and stability of other POM-NP complexes described in the present disclosure. To be noted, the possibility and feasibility of preparing and isolating the POM-NP complexes of the present disclosure, and their stabilities, cannot be assumed and assured based on complexes known in the art for a number of reasons. First, disclosed herein are other combinations of POMs and NPs, which have not been previously disclosed. For example, complexes wherein any of the known POMs described above are complexed with metal oxide NPs, which comprise other metal ions, at least some of these other metal ions and their specific coordinative bonding modes have no structural precedent in molecular complexes. Other complexes contemplated herein involve NPs, which comprise more than one metal cation, i.e., MᵢM′ⱼOₖ NPs, where M and M′ are different metals. Other combinations of POMs and NPs disclosed herein comprise entirely different types of POM ligands.

POM-complexed NPs (POM-NP) disclosed herein are conceptually different form known POM complexes with respect to both structure and reactivity. For example, such conceptual difference concerns the design and synthesis of an entirely new type of POM-coordinated iron-oxide core, and its use as a soluble, non-labile, visible-light driven water oxidation catalyst, with inherent (thermodynamic) stability with respect to oxidative and hydrolytic degradation.

The POM-NP complexes disclosed herein feature structural differences with respect to known complexes and such differences account, e.g., for superior stabilities of the presently disclosed POM complexes compared to known POM complexes. For example, POM-complexed NCs such as those reported by Talapin et al., 2014 (supra) fail to solve the problem of oxidative and/or hydrolytic degradation that occurs when used as soluble water oxidation catalysts. While molecular water-oxidation catalysts feature rapid turnover rates, they are inevitably susceptible to degradation under turnover conditions in water. Metallo-organic catalysts are susceptible to oxidation (of their organic ligands), as well as to hydrolysis, while oxidatively inert polyoxometalate complexes are susceptible to hydrolysis. The degradation processes lead to the formation of reactive colloidal metal oxides whose roles molecular catalysts is controversial.

For example, Talapin et al., 2014 discloses Fe₂O₃ nanocrystals decorated with [P₂Mo₁₈O₆₂]⁶⁻ ligands. In these complexes, the POMs are electrostatically associated with the positively charged metal-oxide cores. Thus, in fact, these complexes are a type of traditional electrostatically stabilized colloidal nanocrystals, obtained by exchanging BF₄⁻ anion by POM anions, and soluble in polar organic solvents. As such, they are inherently labile and susceptible to hydrolysis and/or to exchange with other anions (such as the periodate, IO⁴⁻, used as an oxidant).

Other known POM complexes, for example, those disclosed in Llordés et al. 2013 (supra), are deployed to solubilize metal-oxide nanocrystals in solution for the short times necessary to transfer them to a heating apparatus for high-temperature treatment (calcination). The POM-stabilized materials are not characterized nor were their stabilities explored. They were simply used as precursors to functional ceramic materials formed at high temperatures.

Embodiments of the present disclosure relate to complexes in which the POM ligand is covalently attached to the metal oxide core, for example to hematite cores or zirconium oxide cores, as shown in Examples section herein. These POM are oxidatively inert, yet resistant to hydrolysis and are used, in accordance with embodiments described herein, as covalently attached ligands for water-soluble metal oxide cores. The POM ligands remain covalently attached the to the metal oxide cores at high temperature (e.g., 220° C.) in water. For example, POM complexed hematite disclosed herein is water-soluble and substitutionally inert, as well as inherently stable to oxidation and hydrolysis. Notably, they are stable in water from pH 2 to 8.

The complexes disclosed herein constitute a fundamentally different type of structure compared to known complexes and, most importantly, provide for inherent thermodynamic stability in water. This includes stability to oxidation, hydrolysis, aggregation and/or ligand exchange. The complexes disclosed herein are therefore referred to as “coordination complexes”, embodying a situation conceptually distinct (and unique) from traditional, electrostatically stabilized colloids, such as those disclosed in Talapin et al., 2014. The contemplated POM complexes occupy a unique position between macroanions and traditional (electrostatically stabilized) colloidal NCs. This is a conceptual advance with tremendous implications for the use of metal-oxide nanocrystals in catalysis.

As a result of this inherent stability, the POM-complexed structures of the present disclosure can be deployed as soluble, water-oxidation catalysts (WOCs), more so in visible-light driven catalysis. Moreover, these complexes can be operated for an entire week (7 days) and even more with no decrease in activity whatsoever, a longer time under turnover conditions in water than ever documented for any molecular water-oxidation catalyst. Indeed, in the limited stability test reported in the art (e.g., by Talapin et al., 2014), no solution-state catalysis is demonstrated.

In some applications, it is advantageous to have a highly concentrated solution of POM-complexed metal oxide, metal oxy-hydroxide and/or metal hydroxide NPs. For example, some materials cannot be synthesized in concentrated solutions, hence, they are synthesized in dilute solution and concentrated afterward. The present inventors designed a novel method for producing a stable and fully soluble POM-complexed metal oxide NCs in concentrations of 5-19% w/vol. The successful practice of this method is described in Examples 1-11 herein.

The general approach for achieving concentrated solution is as follows: a high concentration salt solution is added to a purified solution of POM-complexed metal oxide NCs, causing a reversible aggregation due to high ionic strength in the solution. The precipitated material is transferred into a semipermeable dialysis membrane bag, with a permeability for alkali-metal ions diffusion and impermeability for POM-complexed NCs diffusion. The selective permeability enables the salt ions to diffuse through the membrane to an outer water bath due to an osmotic pressure created by the concentration gradient of the salt ions. The removal of alkali-metal salt causes the aggregated material inside the dialysis bag to solubilize, achieving ca. 1% wt/v. With the lower salt concentration, the dialyzed material can be further concentrated by means of gentle air evaporation of centrifugation.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the present disclosure.

As used herein the term “about” refers to ±10%.

The terms “comprises”, “comprising”, “includes”, “including”, “having” and their conjugates mean “including but not limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments described may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable subcombination or as suitable in any other embodiment described herein.

Various embodiments and aspects of the present disclosure as delineated hereinabove and as claimed in the claims section below find experimental support in the following examples.

### EXAMPLES

### Materials

Tin(IV) chloride pentahydrate (SnCl₄·5H₂O, 98+%, Acros Organics), Titanium(IV) isopropoxide (Ti{OCH(CH₃)₂}₄, 97%, Sigma-Aldrich), potassium hydroxide (KOH, 85%, Alfa Aesar), sodium chloride (NaCl, AR, BioLab), potassium chloride (KCl, 99%, Alfa Aesar), lithium hydroxide (LiOH, ≥99.8%, Sigma-Aldrich).

Cellulose dialysis membranes (Spectra/Por 1 Dialysis Membrane MWCO: 6-8,000, nominal flat width 40 mm) were pre-treated before use as per manufacturer instructions.

K₇[α-PW₁₁O₃₉]·12H₂O was synthesized using a known procedure for synthesis of Na₇[α-PW₁₁O₃₉] (Haraguchi et al., Inorg. Chem. 2002, 33(6): 1015-1020. https://doi.org/10.1021/IC00084A008), further involving recrystallization of the POM in the presence of excess KCl to obtain the potassium salt. Obtention of the desired POM was verified by ICP-OES and ³¹P-NMR.

K₈Nb₆O₁₉·10H₂O was prepared as previously described (Kong et al., Dalton Trans., 2013, 42(21): 7699-7709. https://doi.org/10.1039/C3DT00062A), and verified by FTIR and ICP.

Water used for synthesis, purification, and isolation was high purity (18.2 MW resistivity) from a Millipore Direct-Q water-purification system.

### Instruments and Methods

### Inductively Coupled Plasma Optical Emission Spectrometry (ICP-OES)

Data was acquired using Spectro Arcos FHM22 Instrument (AMETEK®) equipped with vertical plasma torch box (SOP) and analyzed using Smart Analyzer Vision software. Samples were diluted to suit the instrument concentration range and were measured without farther treatment.

### Cryogenic Transmission Electron Microscopy (Cryo-TEM)

Cryogenically frozen samples were prepared using Leica, a fully automated vitrification device. Three μL of the sample solution were placed onto a glow discharged 300 Mesh Cu grid covered with a lacey-carbon film, held inside a 100% humidity chamber. The grid was then mechanically “blotted” and immediately plunged into liquid ethane cooled by liquid nitrogen. Data were collected on the FEI Tecnai 12 G2 instrument (120 kV) and the Gatan slow-scan camera, using a low-dose regime). All images from both dry- and cryo-TEM (including electron diffraction patterns) were analyzed using Digital Micrograph Gatan Inc. software.

### Energy Dispersive X-Ray Spectroscopy (EDS)

Measurement was acquired using a JEOL JEM-2100F TEM analytical electron microscope operating at 200 kV equipped with a JED2300T energy dispersive X-ray spectrometer.

### Powder X-Ray Diffraction (PXRD)

Data was obtained using a Rigaku XtaLAB Synergy-S diffractometer (a single crystal X-ray diffractometer for structural analysis of small molecule samples) using Cu Kα radiation operated at 50 kV and 1 mA, equipped with a Hy-Pix-6000HE detector and PANalytical's Empyrean multi-purpose diffractometer, using Cu Kα radiation operated at 40 kV and 30 mA, and a PSD X'Celerator 1D and PIXcel-3D detector.

### Synthesis of POM-Complexed Metal Oxide Nanocrystals

Usually, an aqueous solution of a salt of the desired metal was used as a precursor (also referred to herein as “precursor solution”), and the pH was adjusted, forming a hydrated form of the metal ion. Afterward, the POM was introduced to the solution. The sample was heated hydrothermally in an autoclave to facilitate condensation of the hydrated metal into metal-oxide nanocrystals (NCs) and attachment of the POM ligands to the surface of the metal oxide nanocrystals. The reaction mixture was then separated from the reaction by-products. Using alkali-metal salt, the POM-complexed NCs were selectively and reversibly precipitated, and the soluble by-products were discarded using a centrifuge. The purified complexes were redissolved, and the solution was further concentrated using air evaporation or centrifuge.

Different precursor solutions (e.g., aqueous or organic) may be used for the same metal salt.

### Synthesis of POM-Complexed Binary, Doped and Ternary Metal Oxide Nanocrystals

For the preparation of POM-complexes of NCs comprising two or three different metal cations, two or more precursor solutions were prepared by separately dissolving the salt forms of the metals to be joined or mixed (or structurally combined) in the NCs in either water or water-miscible solvent. The pH of each solution was adjusted if needed. Then, the precursor solutions were combined, while vigorously stirring one solution and, optionally, dropwise adding the other solution. Afterward, POM was introduced, the sample was heated hydrothermally, and the reaction mixture was treated in a similar manner as described above for POM-complexed metal oxide NCs.

In some embodiments, the POM-complexed NCs are controlled to reach a specific size.

### Example 1

### Preparation of [α-PW₁₁O₃₉]⁷⁻-Complexed SnO₂ NCs (Complex 1)

SnCl₄·5H₂O (926 mg, 2.64 mmol; metal salt precursor) was added as solid to 198 mL deionized water. Then, the pH was adjusted to 4.5 with 160 mM LiOH solution (ca. 66 mL, 10.6 mmol), after which a solution of 20 mM of K₇[α-PW₁₁O₃₉] (66 mL, 1.32 mmol) was added. The reaction mixture was stirred for two hours at 25° C., transferred to a Teflon-lined 316 stainless steel reaction vessel and heated in an oven (120° C., 24 hours), and then cooled on the bench to room temperature. An optically clear solution containing [α-PW₁₁O₃₉]⁷⁻-complexed SnO₂ NCs (Complex 1) was obtained.

The isolation of Complex 1 was carried out based on a previously described method (Chakraborty et al., Nat. Commun. 91, 2018, 9 (1): 1-8. https://doi.org/10.1038/s41467-018-07281-z). Briefly, a saturated NaCl solution was added to the cooled reaction mixture to a final salt concentration of 1 M, causing Complex 1 to reversibly precipitate. The cloudy solution was centrifuged (6000 rpm, 5 min), after which the supernatant was discarded, and the pellet was redissolved in water. Two additional isolation cycles of salt addition, centrifugation, and pellet redissolution were performed. Then, the solution was filtered using Millex-HV Syringe Filter Unit (0.45 μm, PVDF, 33 mm) to remove any large impurities. An additional isolation cycle was performed using a minimal amount of water to dissolve the pellet so as to make a slurry containing an isolated suspension of Complex 1, with an excess of NaCl.

For purification, the slurry was transferred to a treated cellulose membrane bag which was then placed in a 1 L water bath for dialysis (16 hours, replacing the water once after an hour). After which, a purified, fully dissolved, and concentrated (ca. 1% w/v) solution of Complex 1 was obtained.

The dialyzed solution was further concentrated using a gentle stream of compressed air to a concentration of 8.5% w/v.

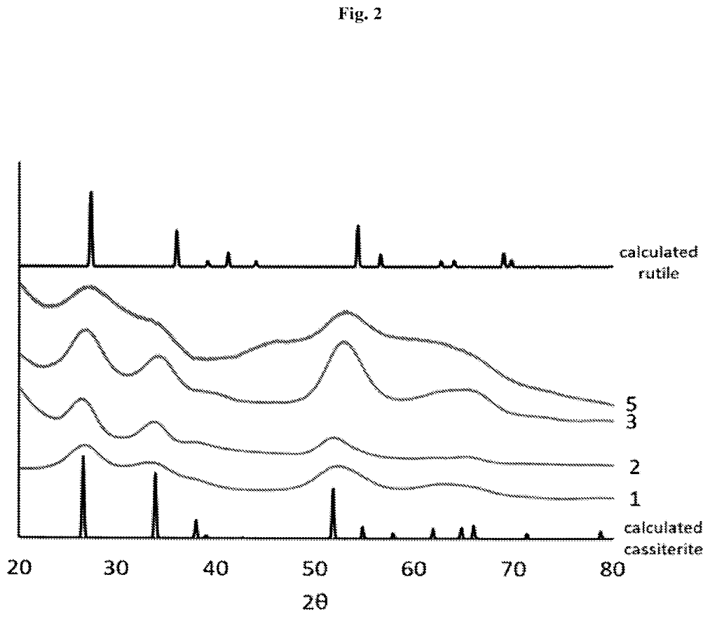

Powder XRD analysis, alongside calculated spectra of rutile TiO₂ and its isomorphous structure, cassiterite SnO₂, shown in FIG. 2, revealed a SnO₂ NC.

Titanium Oxide (TiO₂) has two important types: rutile titanium dioxide and anatase titanium dioxide. Anatase titanium dioxide is colorless, whereas rutile titanium dioxide is usually found in dark red appearance. Rutile titanium dioxide is optically positive, whereas anatase titanium dioxide is optically negative. Rutile TiO₂ is primary ore, and the more stable form of TiO₂ than anatase. Crystals of both rutile and anatase TiO₂ have a tetragonal unit cell. The titanium cations (Ti⁴⁺) have a coordination number of 6, meaning they are surrounded by an octahedron of 6 oxygen atoms. The oxygen anions (O²⁻) have a coordination number of 3, resulting in a trigonal planar coordination. However, the crystalline structures of anatase and rutile titanium dioxides are different due to different degree of distortion of the octahedron in these types of TiO₂.

Cassiterite SnO₂ is a reddish, brownish, or yellowish mineral consisting of tin dioxide (SnO₂). The crystal system is tetragonal, isomorphic (identical or similar) structure to rutile TiO₂.

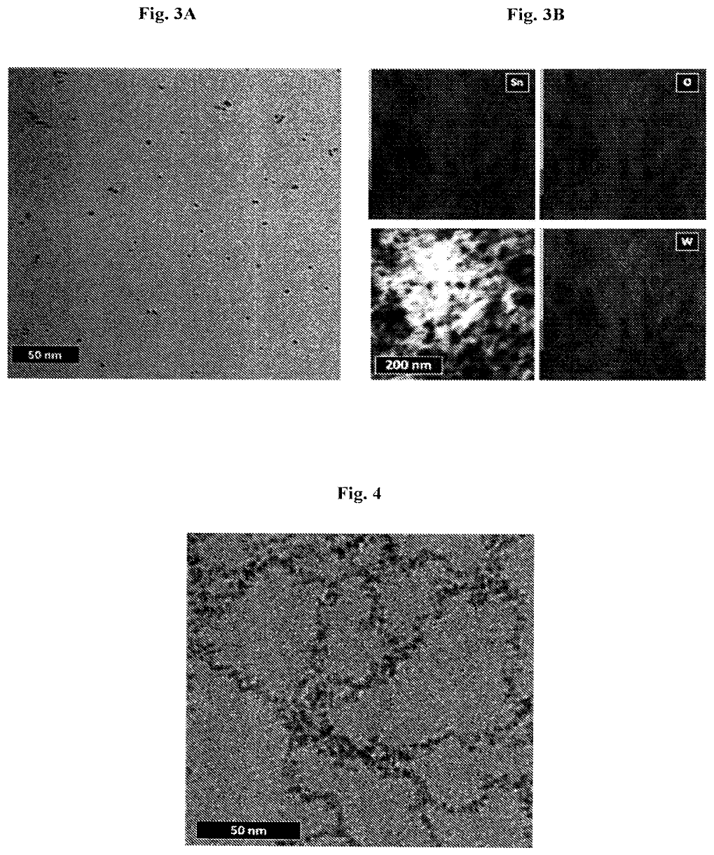

Cryo-TEM image of purified sample of Complex 1, which was acidified to pH 3 to observe individual particles, showed a sub 4 nm NCs (FIG. 3A). Elemental mapping of Complex 1 using EDS in STEM mode showed a homogenous distribution of oxygen tin and tungsten in the sample (FIG. 3B).

ICP-OES measurements of purified Complex 1 are shown in Table 1 below.

### Example 2

### Synthesis of [Nb₆O₁₉]⁸⁻-Complexed SnO₂ NCs (Complex 2)

Solid SnCl₄·5H₂O (938 mg, 2.68 mmol) was added to 342 mL deionized water. Then, the pH was adjusted to 10.5 with 400 M KOH solution (ca. 26.9 mL 10.8 mmol), after which a solution of 20 mM of K₈Nb₆O₁₉ (66 mL, 1.32 mmol) was added. The reaction mixture was stirred for two hours at 25° C., transferred to a Teflon-lined 316 stainless steel reaction vessel, heated in an oven (120° C., 24 hours), and then cooled on the bench to room temperature. An optically clear solution containing [Nb₆O₁₉]⁸⁻-complexed SnO₂ NCs (Complex 2) was obtained. Isolation, purification and concentration of Complex 2 were conducted in as described in Example 1 above, with the distinction of using a saturated solution of KCl instead of NaCl, and concentrating to a final concentration of 18% w/v.

Powder XRD analysis, depicted in FIG. 2, shows a cassiterite SnO₂ structure, which is isomorphic to rutile TiO₂ structure.

ICP-OES measurements of purified Complex 2 are shown in Table 1 below.

### Example 3

### Synthesis of [Nb₆O₁₉]⁸⁻-Complexed Sn_{0.5}Ti_{0.5}O₂ NCs (Complex 3)

SnCl₄·5H₂O (18.4 mg, 52.5 μmol) was added as solid to 12.0 mL deionized water, followed by the addition of a solution of 400 mM KOH (0.23 mL, 91 μmol). Then, a freshly prepared solution of 40 mM titanium-isopropoxide diluted in isopropanol (4 mL, 80 μmol) was added dropwise to the Sn solution under vigorous stirring, resulting in a cloudy white suspension. The suspension was stirred for 30 minutes, after which a solution of 20 mM K₈[Nb₆O₁₉] (4 mL, 80 μmol) was added. The reaction mixture was stirred for an additional two hours at 25° C., transferred to a Teflon-lined 316 stainless steel reaction vessel, heated in an oven (120° C., 20 hours), and then cooled on the bench to room temperature. A solution containing [Nb₆O₁₉]⁸⁻-complexed Sn_{0.5}Ti_{0.5}O₂ binary metal oxide NCs (Complex 3) was obtained. Isolation and purification of Complex 3 were conducted in as described in Example 1 above, with the distinction of using a saturated solution of KCl instead of NaCl.

The dialyzed solution was centrifuged (18000 rcf, 1 hour), which caused the nanosized Complex 3 to migrate to the bottom, resulting in a dense, transparent layer, containing high concentration of Complex 3, and a more dilute top layer. The top layer was discarded, and the bottom layer was redissolved with a small amount of water, achieving a highly concentrated solution of Complex 3, containing up to 15.1% w/v.

Cryo-TEM image of purified sample of Complex 3 (FIG. 4), shows unresolved particles forming a dendrimer aggregate.

Powder XRD analysis, alongside calculated spectra of rutile TiO₂ and its isomorphous structure, cassiterite SnO₂, (FIG. 2), shows mainly a cassiterite SnO₂ structured nanocrystal.

ICP-OES measurements of purified Complex 3 are shown in Table 1 below.

### Example 4

### Synthesis of [Nb₆O₁₉]⁸⁻-Complexed Sn_{0.25}Ti_{0.75}O₂ NCs (Complex 4)

[Nb₆O₁₉]⁸⁻-complexed Sn_{0.25}Ti_{0.75}O₂, comprising binary metal oxide NCs (Complex 4), was synthesized, isolated, purified, and concentrated using the procedures described for Complex 3 (Example 3 above), but adjusting the quantities of SnCl₄·5H₂O (9.3 mg, 26 μmol), deionized water (11.76 mL), 400 mM KOH solution (0.26 mL, 104 μmol). Same amount of K₈[Nb₆O₁₉] (4 mL, 80 μmol) was used. The product was concentrated to 9.2% w/v.

ICP-OES measurements of purified Complex 4 are shown in Table 1 below.

### Example 5

### Synthesis of [Nb₆O₁₉]⁸⁻-Complexed Sn_{0.13}Ti_{0.87}O₂ NCs (Complex 5)

[Nb₆O₁₉]⁸⁻-complexed Sn_{0.13}Ti_{0.87}O₂, comprising binary metal oxide NCs (Complex 5) was synthesized, isolated, purified and concentrated using the procedures described for Complex 3 (Example 3 above), but adjusting the quantities of SnCl₄·5H₂O (7.2 mg, 20 μmol), deionized water (11.42 mL), 400 mM KOH solution (0.58 mL, 230 μmol). The same K₈[Nb₆O₁₉] (4 mL, 80 μmol) was used. The product was concentrated to 17.7% w/v.

PXRD of Complex 5 is depicted in FIG. 2 alongside a calculated spectra of rutile TiO₂ and its isomorphous structure, cassiterite SnO₂. As seen, the rutile structure remained for Complex 5, but the ratios Sn:Ti for Complex 5 were different form Complex 3.

ICP-OES measurements of purified Complex 5 are shown in Table 1 below.

### Example 6

### Synthesis of [Nb₆O₁₉]⁸⁻-Complexed TiO₂ NCs (Complex 6)

Into a 178.3 mL deionized water, a solution of 400 mM KOH (4.5 mL, 1.8 mmol) was added, followed by a dropwise addition of a freshly prepared solution of 40 mM titanium-isopropoxide diluted in isopropanol (59.4 mL, 2.38 mmol), under vigorous stirring, resulting in a slightly cloudy white suspension. Thereafter, a solution of 20 mM K₈[Nb₆O₁₉] (59.4 mL, 1.19 mmol) was added. The reaction mixture was refluxed (80° C., 24 hours) to yield a solution containing [Nb₆O₁₉]⁸⁻-complexed TiO₂ nanoparticles (Complex 6). Isolation and purification of Complex 6 were conducted using the same procedure applied for Complex 1 (Example 1 above), with the distinction of using a saturated solution of KCl instead of NaCl; a concentrated solution of Complex 6 was achieved using the concentrating method described for Complex 3 (Example 3 above), achieving a high concentration of 18.6% w/v.

ICP-OES measurements of purified Complex 6 are shown in Table 1 below.

### Example 7

### Synthesis of [Nb₆O₁₉]⁸⁻-Complexed TiO₂ NCs (Complex 7)

Synthesis, isolation, purification, and concentration of [Nb₆O₁₉]⁸⁻-complexed TiO₂ NCs were conducted using a similar method described for Complex 6 (Example 6 above), but instead of reflux, the reaction was heated hydrothermally. After the addition of 20 mM K₈[Nb₆O₁₉] solution, the reaction mixture was stirred for one hour at 25° C., transferred to a Teflon-lined 316 stainless steel reaction vessel and heated in an oven (180° C., 20 hours), and then cooled on the bench to room temperature. A solution containing [Nb₆O₁₉]⁸⁻-complexed TiO₂ NCs (Complex 7) was obtained. The solution was concentrated to 5% w/v.

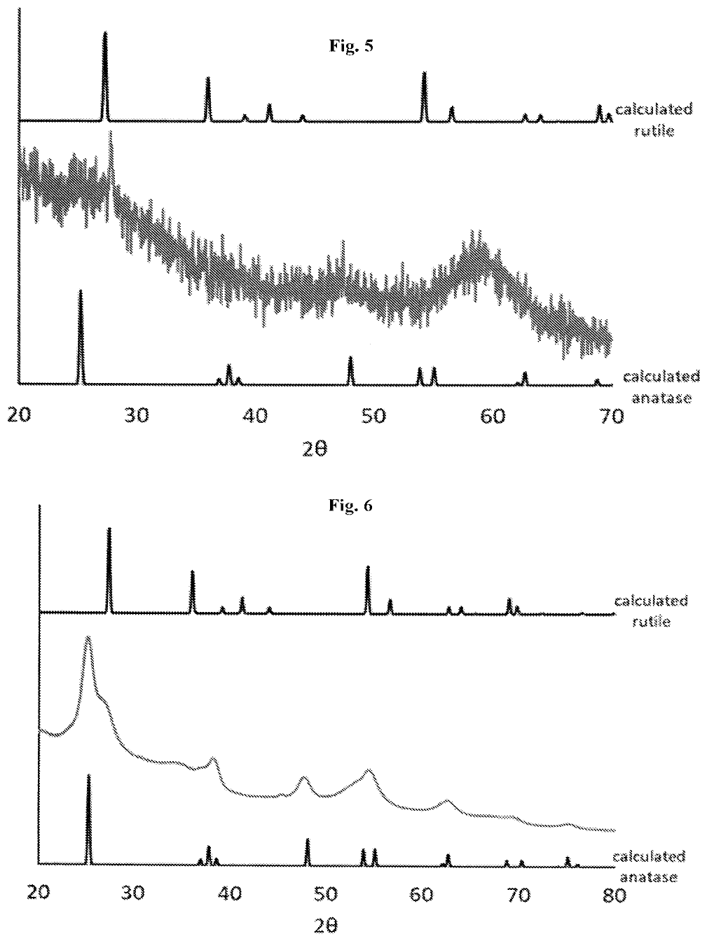

PXRD of Complex 7 revealed an amorphous core as shown in FIG. 5, compared to the calculated spectra of rutile TiO₂ and anatase TiO₂.

ICP-OES measurements of purified Complex 7 are shown in Table 1 below.

### Example 8

### Synthesis of [α-PW₁₁O₃₉]⁷⁻-Complexed Sn_{0.13}Ti_{0.87}O₂ NCs (Complex 8)

Solid SnCl₄·5H₂O (103 mg, 0.294 mmol) was added to 293 mL deionized water. Then, a freshly prepared solution of 10% v/v titanium-isopropoxide in isopropanol (9 mL, 3.1 mmol) was added dropwise under vigorous stirring, resulting in a cloudy white suspension. The pH was adjusted to 4.5 with 0.4 M KOH (ca. 3 mL, 1.2 mmol), followed by addition of K₇[α-PW₁₁O₃₉]·nH₂O (3.71 g, 1.17 mmol) as a crystalline solid. The reaction mixture was stirred for three hours at 25° C., transferred to a Teflon-lined 316 stainless steel reaction vessel, heated (120° C., 17 hours), and then cooled on the bench to room temperature. A solution containing [α-PW₁₁O₃₉]⁷⁻-complexed Sn_{0.13}Ti_{0.87}O₂ NCs (Complex 8) was obtained. Isolation and purification of Complex 8 were conducted using the same procedure applied for Complex 1 (Example 1 above); concentrated solution of Complex 8 was achieved using the concentrating method described for Complex 3 (Example 3 above), to yield 9.4% w/v.

Powder XRD of Complex 8 alongside calculated spectra of anatase and rutile TiO₂, is shown in FIG. 6. As seen, Complex 8 has a mixture of anatase and rutile core NC structure, which could result from a polycrystalline NCs containing both anatase and rutile, or a mixture of two distinct NCs one has anatase core and the other has rutile core.

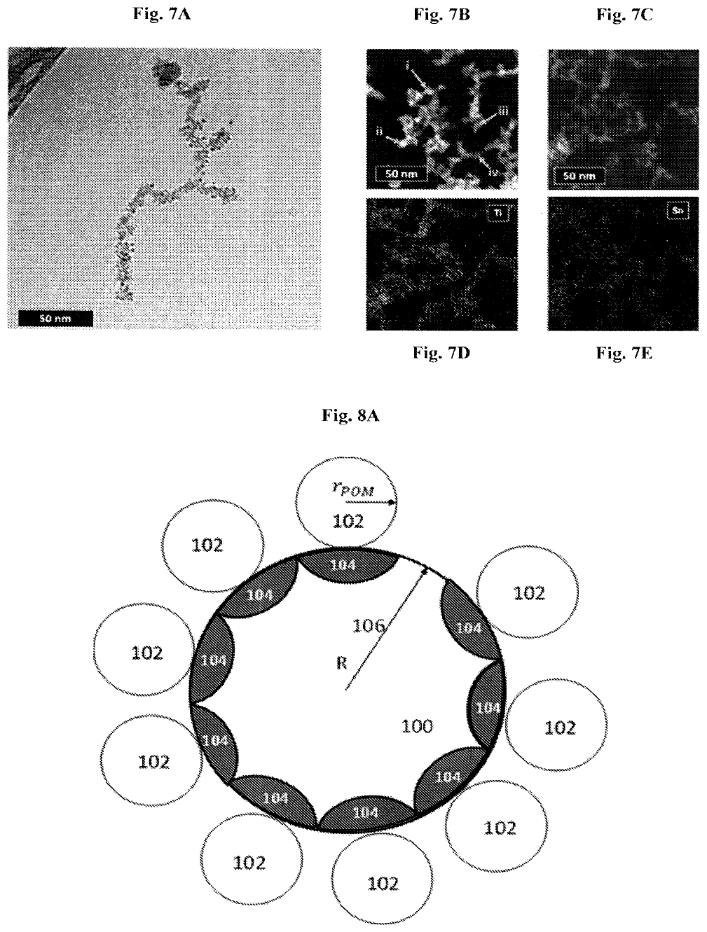

Cryo-TEM image of purified sample of Complex 8 (FIG. 7A), shows unresolved particles forming a dendrimer aggregate.

Elemental quantification of Complex 8 using EDS in point mode (FIG. 7B) with 1 nm point size, probed the percent ratio Ti and Sn of different areas in the sample. Point i had 96% Ti and 4% Sn; point ii had 91% Ti and 9% Sn; point iii had 99% Ti and 1% Sn; point iv had, 87% Ti and 13% Sn. These measurements showed a wide distribution of Ti:Sn ratios.

Elemental mapping of Complex 8 using EDS in STEM mode (Figs. GC-6E) showed a relatively homogenous distribution of tin and titanium in the sample.

ICP-OES measurements of purified Complex 8 are shown in Table 1 below.

### Example 9

### Synthesis of [α-PW₁₁O₃₉]⁷⁻-Complexed TiO₂ NCs (Complex 9)

### Synthesis of the POM Complexed Anatase

TiO₂ NCs was carried our based on a published method (Raula et al., Angew. Chemie Int. Ed., 2015, 54(42):12416-12421. https://doi.org/10.1002/ANIE.201501941). Briefly: into a 369 mL deionized water, a freshly prepared solution of 10% titanium-isopropoxide v/v in isopropanol (8.9 mL, 3.0 mmol) was added dropwise under vigorous stirring, resulting in a cloudy white suspension. Then, K₇[α-PW₁₁O₃₉]·12H₂O (4.79 g, 1.51 mmol) was added as a crystalline solid. The reaction mixture was stirred for 10 minutes at 25° C., transferred to a Teflon-lined 316 stainless steel reaction vessel, heated in an oven (170° C., 20 hours), and then cooled on the bench to room temperature. An optically clear solution containing [α-PW₁₁O₃₉]⁷⁻-complexed TiO₂ NCs (Complex 9) was obtained. Isolation and purification of Complex 9 were conducted using the same procedure applied for Complex 1 (Example 1 above); concentrated solution of Complex 9 was achieved using the concentrating method described for Complex 3 (Example 3 above), to yield 10.7% w/v.

ICP-OES measurements of purified Complex 9 are shown in Table 1 below.

### Example 10

### Synthesis of [α-PW₁₁O₃₉]⁷⁻-Complexed TiO₂ NCs (Complex 10)

[α-PW₁₁O₃₉]⁷⁻-complexed anatase TiO₂ was prepared using a slight modification of the procedure taught by Raula et al., 2015 (supra), wherein a diluted solution of titanium-isopropoxide was used. Briefly: into a 178 mL deionized water, a freshly prepared solution of 40 mM titanium-isopropoxide, diluted in isopropanol (59.4 mL, 2.38 mmol) was added dropwise under vigorous stirring, resulting in a cloudy white suspension. Then, mM solution of K₇[α-PW₁₁O₃₉] (59.4 mL, 1.19 mmol) mmol) was added. The reaction mixture was stirred for an hour at 25° C., transferred to a Teflon-lined 316 stainless steel reaction vessel, heated in an oven (180° C., 20 hours), and then cooled on the bench to room temperature. An optically clear solution containing [α-PW₁₁O₃₉]⁷⁻-complexed TiO₂ NCs (Complex 10) was obtained. Isolation and purification of Complex 10 were conducted using the same procedure applied for Complex 1 (Example 1 above); concentrated solution of Complex 10 was achieved using the concentrating method described for Complex 3 (Example 3 above) to yield 5% w/v. The addition of a more diluted titanium-isopropoxide solution resulted in a higher ligand content in the final product.

ICP-OES measurements of purified Complex 9 are shown in Table 1.

TABLE 1
ICP-OES measurements of purified complexes

| Complex | K | Na | Nb | Sn | Ti | W |
|---|---|---|---|---|---|---|
| number | (ppm) | (ppm) | (ppm) | (ppm) | (ppm) | (ppm) |
| 1 | 0.31 | 3.99 | | 83.73 | | 67.36 |
| 2 | 6.20 | | 28.53 | 61.18 | | |
| 3 | 5.88 | | 16.87 | 26.73 | 8.45 | |
| 4 | 10.82 | | 23.96 | 16.08 | 18.45 | |
| 5 | 24.65 | | 48.96 | 16.62 | 45.14 | |
| 6 | 56.71 | | 31.19 | | 56.37 | |
| 7 | 7.30 | | 10.82 | | 12.48 | |
| 8 | | 2.28 | | 8.96 | 25.01 | 36.95 |
| 9 | 0.40 | 1.65 | | | 36.34 | 40.59 |
| 10 | 0.49 | 3.91 | | | 43.09 | 52.58 |

### Example 11

### Calculation of POM-Complexed Metal Oxide Nanoparticle Core Radius

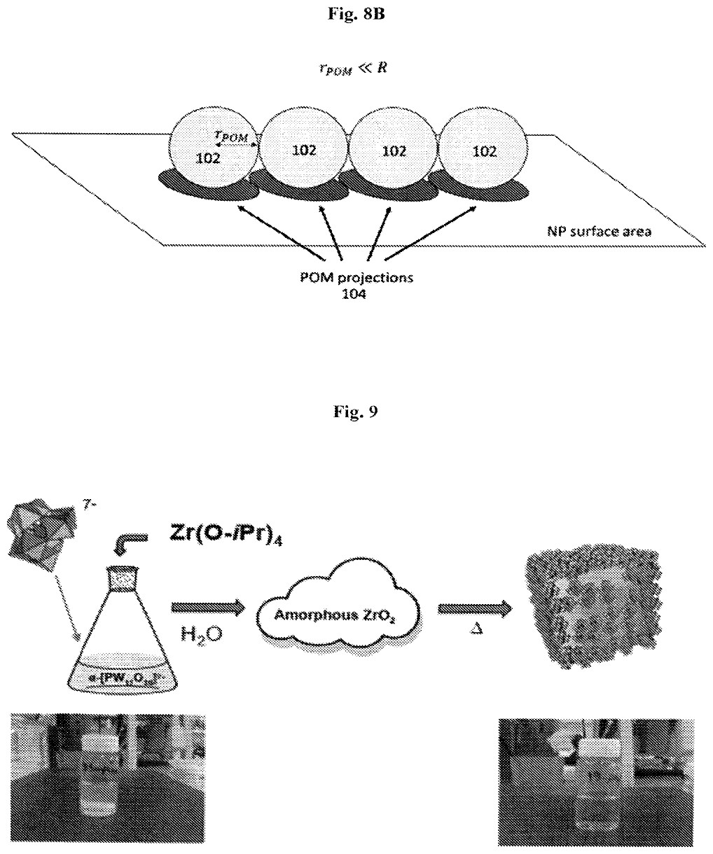

The radii of POM-complexed NPs cores were estimated using the following calculations, which are based on some geometrical constrains such as the minimum distance of adjacent POMs on the surface of the core, and assuming that both the NP core and the decorating POMs are perfect spheres (FIGS. 8A-8B). The concentration of POM ligands was used to calculate the total projected area of the POMs on the core surface. In FIG. 8A, a NP (100) with radius R (106) complexed to m POMs (m=9) is shown. The projections (104) of some of the POMs on the NP spherical surface are shown as darker features. For the case where the NP's radius is much larger than the POM radius, the surface of the NP is considered as a plane. FIG. 8B illustrates the packing of the POM spheres on a large NP and shows the projections of the POMs on the plane surface.

The parameters and notations used for calculating the estimated nanoparticle (core) effective radius R are listed in Table 2:

TABLE 2
Nanoparticles core radius calculation parameters

| Parameter | | | |
|---|---|---|---|
| notation | Units | Parameter | Comment |
| R | nm | Nanoparticle (NP) radius | Calculated |
| MW^{a} | g/mol | Molecular weight of the metal | Calculated for each empirical |
| | | oxide empirical formula/unit | formula (e.g., 79.87 g/mol for |
| | | | TiO₂) |
| [M] | mol/L | NP metal atom concentration | measured with ICP-OES |
| ρ^{b} | g/nm³ | Density of the metal oxide NP | Obtained from the crystal |
| | | | structure as measured by |
| | | | XRD |
| N_{A} | | Avogadro's number (1/mol) | |
| [POM] | mol/L | POM concentration | Measured the element with |
| | | | ICP-OES; calc. by molar conc. |
| | | | of element divided by |
| | | | number of elements in |
| | | | formula e.g. Nb₆O₁₉ → divide |
| | | | by 6 |
| r_{POM} | m | POM radius (nm) | Computed according to |
| | | | values extracted from |
| | | | academic literature^{c} |
| p_{f} | | Packing factor ^{~}0.91 for | https://mathworld.wolfram.com/ |
| | | hexagonal packing | CirclePacking.html |
| NPₘ | | NP mass | |
| r | | Number of empirical units in the | |
| | | NP | |
| [NP] | mol/L | NP concentration | |
| m | | Number of POMs covering a NP | |

^{a}for NP core comprising more than one kind of metal cation, the weighted average of the molecular weights of the different metals was used.
^{b}for polycrystalline NP core, the density of the less dense crystalline form was considered; for amorphous TiO₂, 3 · 10⁻²⁴ g/nm³ was considered
^{c}POM effective radius, r_{POM}, was used based on values taken from Weinstock et al. J. Am. Chem. Soc. 2009, 131, 47, 17412-17422; and Nyman et al., J Clust Sci, 2006, 17: 197-219.

The following assumptions were made:
(1) the cores (NP) are spherical;
(2) the number of POMs covering the NP is smaller than the number of core empirical units or empirical formula (e.g., TiO₂);
(3) the curvature of the core NP is not considered in geometric modeling;
(4) all the metal atoms in the core NP are in the form of metal-oxides;
(5) the core radius is larger than the POM radius (R>r_{POM}).

The mass of a NP (NPₘ) is given by formula (i), assuming a spherical structure with radius R and density of the relevant crystal structure ρ:

$${NP}_{m} = \frac{4}{3} π {R}^{3} \cdot ρ \qquad ( i )$$

The number of core empirical units, r, can be calculated by dividing the NP mass by the molecular weight, MW, of the empirical formula, using formula (ii):

$$r = \frac{{NP}_{m} \cdot {N}_{A}}{MW} = \frac{\frac{4}{3} π {R}^{3} \cdot ρ \cdot {N}_{A}}{MW} \qquad ( ii )$$

The NPs concentration in 1 liter ([NP], mol/L) is given by [M]/r, namely, the concentration of the metal atom in the NP ([M], measured by ICP-OES) divided by the number of empirical units, r, in a single NP.

The POM concentration in 1 liter ([POM], mol/L) is a function of NP concentration [NP] and is calculated by formula (iii):

$$[ POM ] = m * [ M ] / r \qquad ( iii )$$

Formula (iii) can be used to calculate m by inserting formulae (i) and (ii):

$$m = r \cdot \frac{[ POM ]}{[ M ]} = \frac{\frac{4}{3} π {R}^{3} \cdot ρ \cdot {N}_{A} \cdot [ POM ]}{MW \cdot [ M ]}$$

The surface area of the NP is given by: A=4πR².

The area of a single POM's projection on the core surface is given by: πr_{POM}², wherein r_{POM} is the POM radius.

The total area of POMs projection on the surface of the NP can be calculated by multiplying the area of one POM projection by the number of POMs per NP, m, using equation (iv):

$$projections of POMs on cores = m \cdot π {r}_{POM}^{2} = \frac{\frac{4}{3} π {R}^{3} \cdot ρ \cdot {N}_{A} \cdot [ POM ]}{MW \cdot [ M ]} \cdot π {r}_{POM}^{2} \qquad ( iv )$$

The total surface area of the POMs projection on the NP core surface also depends on the POMs packing factor p_{f} (which is ^{˜}0.91 for hexagonal packing) as well as on the surface area of the core NP. The packing factor accounts for the coverage efficiency of closed pack collection of circles on a given area. Thus:

(surface of a NP)×(packing factor)=sum of projections of POMs on NP surface

and using the formulae above:

$${p}_{f} \cdot 4 π {R}^{2} = \frac{\frac{4}{3} π {R}^{3} \cdot ρ \cdot {N}_{A} \cdot [ POM ]}{MW \cdot [ M ]} \cdot π {r}_{POM}^{2}$$

Finally, R was calculated by:

$$R = \frac{3 \cdot MW \cdot [ M ] * {p}_{f}}{ρ \cdot {N}_{A} \cdot [ POM ] \cdot π {r}_{POM}^{2}}$$

Nanoparticles size is not uniform, subjected to a variance depending on the exact composition and synthesis method. Although R, as calculated herein, is a product of the various approximations and assumptions described above, as well experimental errors in measuring the values [POM] and [M], it, nevertheless provides a reasonable and reliable estimate of the NP core radius. Therefore, it is expected that the mean radius is within ±30% of the calculated one.

The calculated maximum radii of NP cores of Complexes 1 to 10 are listed in Table 3.

TABLE 3
Calculated maximum core radii

| Complex | |
|---|---|
| number | Calculated maximum core radius (nm) |
| 1 | 1.05 |
| 2 | 1.6 |
| 3 | 2.45 |
| 4 | 2.15 |
| 5 | 1.95 |
| 6 | 4.25 |
| 7 | 2.7 |
| 8 | 2.75 |
| 9 | 1.85 |
| 10 | 1.7 |

### Example 12

### Synthesis of [α-AlCr(V)W₁₁O₄₀]⁶⁻-Complexed ε-MnO₂ NCs (Complex 11)

In this complex, POM is a heteropolytungstate and the core nanoparticles are the metal oxide MnO₂ nanocrystals. K₉[AlW₁₁O₃₉]·13H₂O (0.2 mmol) was added into a three necked flask containing 100 mL Milli-Q water (distilled water that has gone through more filters). The solution was heated to 60° C., and 1 eq. of Cr[NO₃]₃·9H₂O dissolved in water ([Cr(III)]=0.25 Mm, 8 mL total), was added to the solution. A color change from colorless to green was observed. The solution was heated under reflux to 110° C. while vigorously stirring, and then 3 portions amounting to 0.66 eq. of K[MnO₄] were added in 30-minute intervals. The reaction (which was followed by UV-vis) was the oxidation of Cr(III) in the POM to Cr(V), while reducing the equivalent amount of Mn(VII) to Mn(IV) and covalently attaching via oxo bridges the POM to the MnO₂ core. The final color was an optically transparent, pH 5 magenta solution.

In order to purify the product, 2 M KCl were added to the magenta solution, resulting in the precipitation of the complexes as dark brown solid. Under these conditions, the ionic strength in the solution increased, leading to reversible aggregation of the POM-capped MnO₂ cores, thereby decreasing their solubility in water and enabling their separation from the supernatant solution by centrifugation (15 min at 4000 rpm). Thereafter, the supernatant was decanted, leaving a moist residue of the complexes. After separation, the complexes were readily re-dissolved in a small amount of pure water (15 mL) to produce an optically transparent, brown pH 7 solution. This process was repeated several times to remove any byproducts, which consisted of unreacted MnO₄⁻ and [AlCr(V)W₁₁O₄₀]⁶⁻, until the UV-vis spectrum of the supernatant confirmed the sole presence of water. In the next step, the 15 mL solution was placed in a cellulose membrane against pure water in a 1 L beaker for 24 hrs, replacing the water once every 8 hrs so as to ascertain that trace amounts of KCl salt and any POMs were no longer present in the solution. The dialysis was performed for 72 hrs, as further described herein below.

### Example 13

### Synthesis of [α-PW₁₁O₃₉]⁷⁻-Complexed CeO₂ NCs (Complex 12)

In this complex, POM is a heteropolytungstate and the core nanoparticles are the metal hydroxide CeO₂ nanocrystals. (NH₄)₂Ce(NO₃)₆ (49.3 mg, 89.9 μmol) was added as solid to 10 mL deionized water. Then, while stirring, the pH was adjusted to ca. 3.6 with 200 mM NaOH solution (1.66 mL, 332 μmol), and the solution was stirred for six hours. Thereafter, a solution of 40 mM of Na₇[α-PW₁₁O₃₉] (0.75 mL, 30 μmol) was added and the solution was stirred for additional 16 hours. Another aliquot of Na₇[α-PW₁₁O₃₉] was added (0.50 mL, 20 μmol) and the solution was stirred for additional hour. The final reaction volume was adjusted to 15 mL and stirred 6 more hours. Then, the reaction mixture was transferred into Teflon-lined 316 stainless steel reaction vessel, heated in an oven (180° C., 40 hours), and then cooled on the bench to room temperature. An optically clear solution containing [α-PW₁₁O₃₉]⁷⁻-complexed CeO₂ NCs (Complex 12) was obtained.

### Example 14

### Synthesis of [α-PW₁₁O₃₉]⁷⁻-Complexed ZrO₂ NC (Complex 13)

POM ligands with tunable redox potentials can provide new options for rationally controlling the reactivity of semiconductor nanocrystals. An extraordinary assembly of covalently coordinated POM cluster-anions serving as ligands for water soluble anatase-TiO₂ nanocrystals is described in Examples 9 and 10 herein. This method was extended and adapted for nanocrystals of an additional early transition-metal oxide nanoparticles, ZrO₂.

One equivalent (4 mM) zirconium isopropoxide (Zr-iPr) was added to 10 mL aqueous solution containing 1 equivalent (4 mM pH 6.9) of Na₇PW₁₁O₃₉ (a Keggin structure POM). Rapid hydrolysis of the Zr-iPr gave a cloudy solution containing micron-sized particles of amorphous ZrO₂. The pH remained unchanged. The slurry was placed in a 23 mL Teflon-lined 316 stainless-steel reaction vessel and heated in the oven at 180° C. for 18 hours. Reactions of amorphous ZrO₂ in water with the 1 nm lacunary Keggin ion, PW₁₁O₃₉⁷⁻, yielded an optically clear solution containing Complex 13. The synthesis of Complex 13 is schematically shown in FIG. 9.

Isolation and purification were carried out as follows. Any POMs remaining in the solution were removed by first precipitating the nano-sized POM-capped ZrO₂ by addition of NaCl (to a final concentration of 2 M). Under these conditions, reversible aggregation of the POM capped ZrO₂ nanocrystals decreases their solubility in water, allowing their separation from the supernatant solution by centrifugation (45 min at 6000 rpm). Notably, millimolar concentrations of the primary POM by-product, were fully soluble in 2 M NaCl. After decanting the supernatant solution by pipette, the product, a hydrated white solid, was redissolved in 10 mL of pure water, to give a clear, colorless solution. Three additional “washing” cycles of precipitation by addition of NaCl, followed by centrifugation and redissolution in pure water, were carried out to assure that trace amounts of the POM were no longer present. The solution was placed in a cellulose membrane and dialyzed against pure water (1 L) in a 2 L beaker for 48 h, during which time, the water outside the dialysis membrane was replaced every ^{˜}12 hours. This removed a significant amount of the polyoxometalate by-products (verified by UV-vis), and the residue salt from the “washing” process.

### Example 15

### Evaluating the Mode of α-PW₁₁O₃₉⁷⁻ Ligands Binding to ZrO₂ Nanocrystals

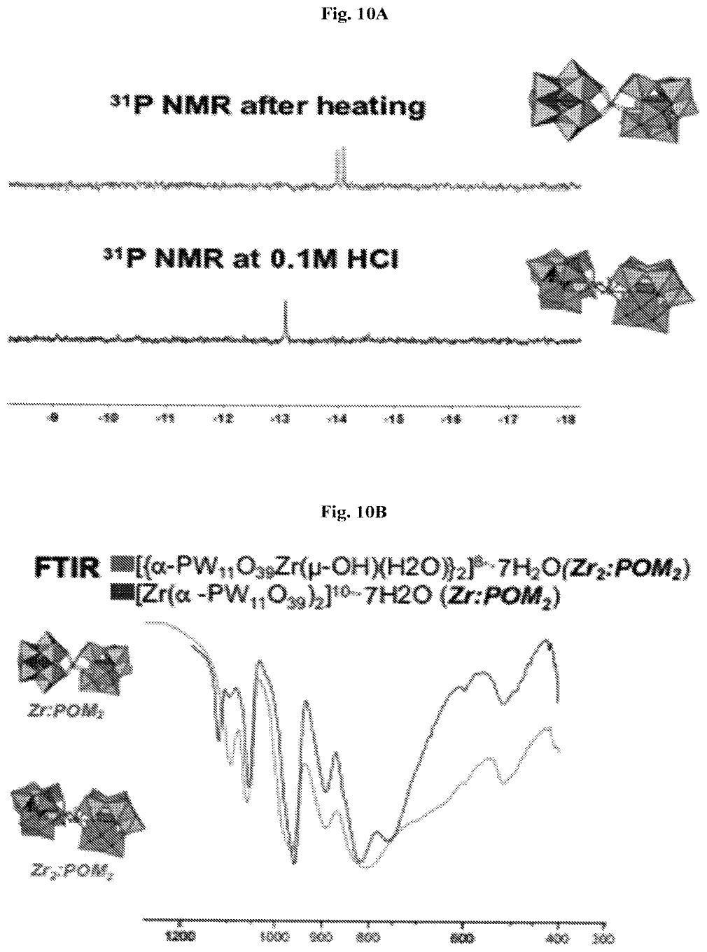

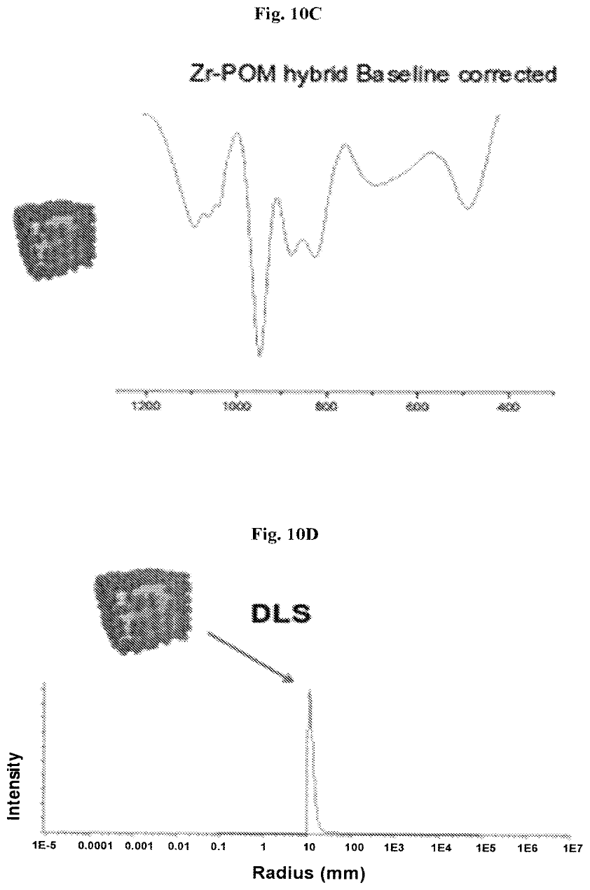

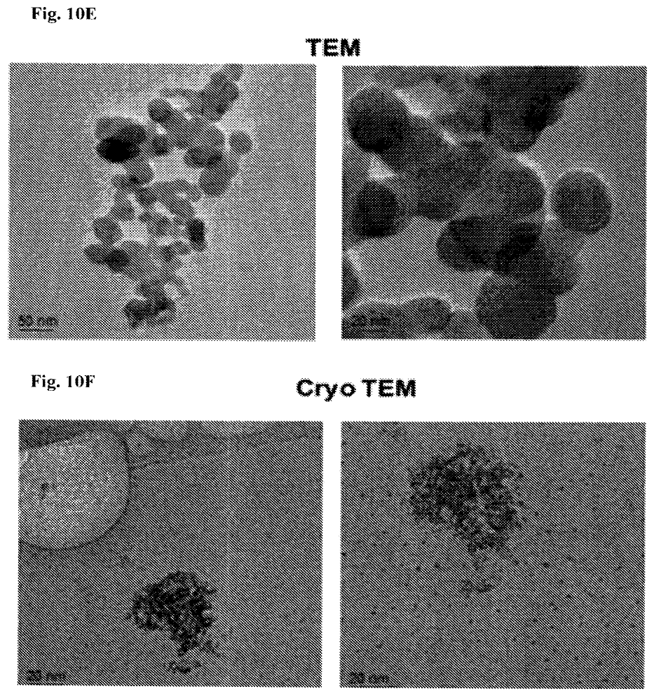

Multiple lines of evidence show that derivatives of Keggin and Wells-Dawson anions can be covalently attached to TiO₂ nanocrystals in water, however, information concerning the atomic connectivity of POM ligands to metal-oxide nanocrystals is extraordinarily difficult to obtain. The binding mode of the POM PW₁₁O₃₉⁷⁻ ligands to ZrO₂ nanocrystals was evaluated for Complex 13 (α-PW₁₁O₃₉⁷⁻-complexed ZrO₂) prepared in Example 14 above. The large number of PW₁₁O₃₉⁷⁻ ligands on each ZrO₂ nanoparticle, combined with the sensitivity of the infra-red (IR) bands arising from the central PO₄ units of the POM ligands, made it possible to observe at least two distinct binding modes (atomic connectivities) to the Zr nanoparticles. This situation was supported by IR data obtained from two optional mode of molecular “out-of-pocket” PW₁₁O₃₉⁷⁻ complexes of Zr(IV), serving as reference points: (i): a dimeric (PW₁₁O₃₉⁷)₂Zr₂ complex, [{α-PW₁₁O₃₉Zr(μ-OH)(H₂O)}₂]⁸⁻·7H₂O), herein designated “Zr₂:POM₂”; and (ii) a “sandwich” complex (PW₁₁O₃₉⁷)₂Zr, [Zr(α-PW₁₁O₃₉)₂]¹⁰⁻·7H₂O, herein designated “Zr:POM₂”. The various complexing modes are verified and supported by the spectral results shown in FIGS. 10A-10F.

As shown in FIG. 10A, ³¹P NMR peaks from the central PO₄ units of sandwich complexes Zr:POM₂ (PW₁₁O₃₉⁷)₂Zr differed substantially from those of dimeric complexes Zr₂:POM₂. Also, the Fourier transform infrared (FTIR) spectroscopy bands (FIG. 10B) of the two reference complexes differed from each other and from the bands of POM-complexed ZrO₂ nanoparticles (Complex 13) shown in FIG. 10C. Further data from dynamic light scattering (DLS; FIG. 10D), transmission electron microscopy (TEM; FIG. 10E) and cryo-TEM (FIG. 10F) of Complex 13 confirmed the formation of ca. 30 nm ZrO₂ nanoparticles capped with the POM ligands. FTIR data pointed towards two distinct out-of-pocket bindings modes for complexation of the lacunary (vacant or mono-defect) POM with Zr atoms at the nanoparticle surface.

Covalent coordination of a polyoxometalate to ZrO₂ nanoparticles has been achieved for the first time, giving highly stable and water-soluble macroanion-like assemblies.

### Example 16

### Reduction of POM on the Surface of ZrO₂ Nanocrystals

Through their tunable redox properties, POM ligands can systematically control the photochemical reactivity of TiO₂ nanocrystals in various reactions such as in H₂ production from methanol. New mechanistic data show that, under turnover conditions, reduced POM ligands funnel electrons into the TiO₂ cores. However, because both the reduced POM ligands and the reduced TiO₂ cores absorb visible light over similar ranges of wavelengths (both are “blue” in color), it is not possible to observe the reduced POMs by UV-vis spectroscopy. To obtain direct evidence of POM reduction during H₂ formation, POM complexes of ZrO₂ nanoparticles were prepared as described in Example 14 above. It was reasoned that, because the ZrO₂ cores are much more difficult to reduce than TiO₂, the POM ligands may be selectively reduced.

UV spectra of reduced POM covalently attached at the surface of ZrO₂ nanocrystal are shown in FIG. 11A. As seen, the UV-vis spectra of the irradiated Zr-POM complex presented a maxima at ca. 620 nm. This maximum increased with irradiation time (FIG. 11B).

Zr(IV) is considerably more difficult to reduce than Ti(IV). The POM-complexed zirconium oxide provided an opportunity to directly observe the reduction of the redox-active POM ligands by UV-vis spectroscopy. IR and UV-vis spectra of these complexed materials shed new light on the structure and reactivity of their TiO₂ analogs.

### Example 17

### Synthesis of [α-PW₁₁O₃₉]⁷⁻-Complexed HfO₂ NC (Complex 14)

In this complex, POM is a heteropolytungstate and the core nanoparticles are the metal oxide HfO₂ nanocrystals. Into a glass vial, 1.333 mL of 60 mM concentrated Na₇[α-PW₁₁O₃₉] solution was added to 6.547 mL of pure H₂O (final concentration 8 mM). Separately, 0.0381 g of HfOCl₂ were dissolved in 2 mL H₂O. While stirring, 1.720 mL of this solution was added dropwise to the POM solution in the vial (final concentration of Hf was 8 mM) then, 0.4 mL of 0.1 M NaOH solution were added dropwise to the vial to a total of 10 mL volume. The pH was 6.85. The solution was kept under stirring for two hours at room temperature. Then, the solution was transferred to 23 mL Teflon liner and tightly sealed in Parr acid digestion bomb. Parr's acid digestion bombs are chemically-inert vessels in which microwave heating can be used for rapid sample dissolution in a sealed vessel. These bombs are suitable for dissolving or digesting inorganic or organic samples in strong acids or alkalis at elevated temperatures and pressures, with complete containment and recovery. The bomb was heated in an oven for 24 hours at 200° C. After the solution cooled to a room temperature, the residue byproducts were filtered out using a 450 nm polyvinylidene difluoride (PVDF) membrane filter to yield a clear solution containing POM-capped or overcoated HfO₂ nanoparticles.

The isolation and purification were carried similarly as described for the [α-PW₁₁O₃₉]⁷⁻-complexed ZrO₂ nanoparticles (Complex 13, Example 14 above). Any POMs remaining in the solution were removed by first precipitating the nano-sized POM-complexed HfO₂ by addition of NaCl (to a final concentration of 2 M). Under these conditions, reversible aggregation of the POM-complexed HfO₂ nanocrystals decreased their solubility in water and afforded their separation from the supernatant solution by centrifugation (45 min at 6000 rpm). Notably, millimolar concentrations of the primary POM byproduct, were fully soluble in 2 M NaCl. After decanting the supernatant solution by pipette, the product, a hydrated white solid (Complex 14), was redissolved in 10 mL of pure water, to give a clear, colorless solution. Two additional “washing” cycles of precipitation by addition of NaCl, followed by centrifugation and redissolution in pure water, were carried out to ascertain that trace amounts of the POM were no longer present. The solution was placed in a cellulose membrane and dialyzed against pure water (1 L) in a 2 L beaker for 48 h, during which time, the water outside the dialysis membrane was replaced every ^{˜}12 hours. This removed a significant amount of the polyoxometalate byproducts (verified by UV-vis) and the residue salt from the “washing” process.

### Example 18

### Synthesis of [Nb₆O₁₉]⁸⁻-Complexed Co(OH)₂ Nanocrystals (Complex 15)

In this complex, POM is a hexaniobate and the core nanoparticles are the metal hydroxide Co(OH)₂ nanocrystals.

K₈Nb₆O₁₉·10H₂O was prepared as previously described (Kong et al., Dalt. Trans., 2013, 42(21): 7699-7709. https://doi.org/10.1039/C3DT00062A), with minor modification. Briefly, to 125 mL Parr acid digestion bomb, 7.5 g of Nb₂O₅ and 45 mL of 3 M KOH were inserted and then heated in an oven for 3 hours at 230° C. After filtering unreacted salt, ethanol was added to the clear solution resulting in precipitation out of potassium hexaniobate. The hexaniobate salt was filtered and dried at room temperature. The structure was verified by XRD and FTIR.

In order to prepare the POM-complexed Co(OH)₂, 0.272 g (0.2 mmol) of K₈Nb₆O₁₉·10H₂O were dissolved in 50 mL H₂O in a 100 mL round bottom flask. The pH of the solution was 12.3. While stirring vigorously, 0.1164 g (0.4 mmol) of Co(No₃)₂ were added. The solution became cloudy purple. Continuous overnight stirring at room temperature, gradually turned the solution clear, resulting in ca. 20 nm sized particles observed by dynamic light scattering (DLS).

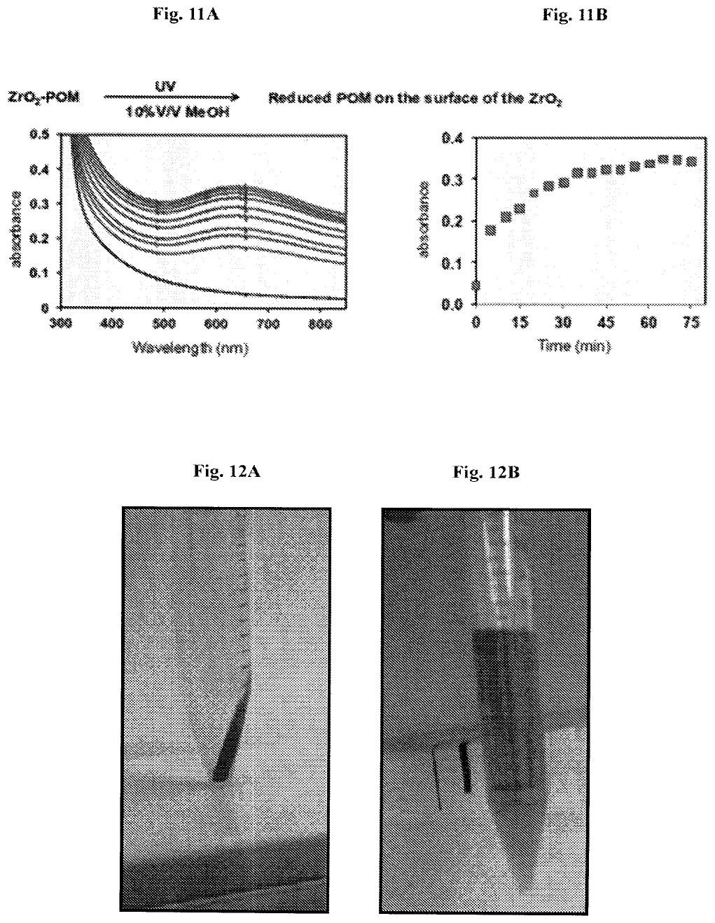

It has been previously shown that increasing the ionic strength of the reaction solution by addition of highly soluble salt, caused reversible aggregation of the nanoparticles. Since the solubility of the non-complexed, molecular hexaniobate increases as the counter cation size is increasing, CsCl salt was used in order to separate the POM-complexed Co(OH)₂ from the molecular hexaniobate byproduct. The nano-sized POM-complexed Co(OH)₂ was first precipitated by addition of CsCl (final concentration of 1 M). Then, the cloudy solution was inserted into a centrifuge for 10 minutes at 6000 rpm. Under these conditions, the nanoparticles remain at the bottom of the Eppendorf while the molecular hexaniobate which is soluble, remained in the supernatant (FIG. 12A). The supernatant solution was decanted by pipette and the hydrated purple solid was dissolved in 10 mL pH 9 CsOH solution, resulting in clear purple solution (FIG. 12B). The “washing” procedure of precipitation with salt, centrifugation and re-dissolution in pH 9 CsOH solution was carried out three times until no POM byproduct was present in the supernatant (verified by UV-vis measurement). Any remaining traces of byproducts such as POM, CsCl, NO₃, were removed using 24 h dialysis in a cellulose membrane, alongside 1 liter of pH 9 CsOH solution. The counter solution was replaced 3 times during the dialysis process. After dialysis, the isolated and purified nanocrystals solution was stored at room temperature. In experiments where solid material was needed, the solution containing the purified product was dried in rotary evaporator to yield purple crystals (Complex 15).

### Example 19

### Synthesis of [Nb₆O₁₉]⁸⁻-Complexed CuO Nanocrystals (Complex 16)

In this complex, POM is a hexaniobate and the core nanoparticles are the metal oxide CuO nanocrystals. The hexaniobate-complexed NCs were synthesized by a simple hydrothermal method. Briefly, CuCl₂·2H₂O (13.64 mg, 0.08 mmol) was dissolved into 8 mL of deionized water and stirred for 10 minutes to obtain a light blue solution (pH ^{˜}5). The hexaniobate ligand, K₈Nb₆O₁₉·16H₂O (58.5 mg, 0.040 mmol) was added, followed by the addition of freshly prepared 1 N NaOH (0.16 mL, 0.160 mmol) to raise the pH to ^{˜}12. This resulted in a sky-blue solution. Deionized water was added to reach a final volume of 10 mL. The sky-blue solution was stirred (900 rpm) at room temperature for 24 hours to ensure complete hydrolysis of copper (II) ions. The crude [Nb₆O₁₉]⁸⁻-complexed CuO nanocrystals were obtained as a clear green solution after 24 hours of hydrothermal reaction in a 23 mL Teflon-lined 316 stainless-steel reaction vessel at 180° C.

For isolation and purification, the nano-sized hexaniobate-complexed CuO (Complex 16) was first precipitated by the addition of 1 M KCl. Under these conditions, reversible aggregation of Complex 16 decreased its solubility in water, affording its separation from the supernatant solution by centrifugation (30 min at 6000 rpm). Notably, millimolar concentrations of the primary hexaniobate byproducts and unreacted CuCl₂ were fully soluble in 1 M KCl and remained in the supernatant solution. After decanting the supernatant solution by pipette, a hydrated dark-green solid was collected and dissolved in 10 mL of pure water, to give a clear, green solution. Two additional purification cycles of precipitation by the addition of KCl, followed by centrifugation and re-dissolution in pure water were carried out to ascertain that trace amounts of byproducts were no longer present. Any remaining traces of byproducts still present in the solution, along with small amounts of KCl precipitated out with the nanocrystals, were removed by dialysis for 48 h in pure water (1 L). This involved placing the solution in a cellulose membrane in a 1 L beaker, during which time the water outside the dialysis membrane was replaced every 12 hours.

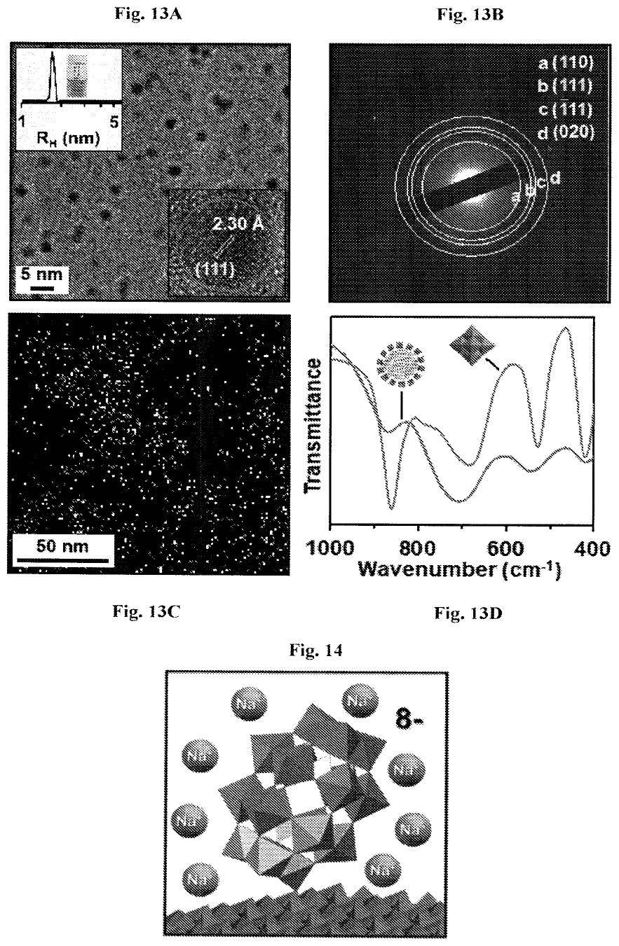

Purification via three cycles of precipitation by KCl addition, centrifugation and dissolution in pure water gave a clear solution, for which (see upper inset to FIG. 13A), indicated particles with an average radius of 1.7±0.1 nm. This stability to aggregation, along with solubility after repeated precipitation, plus a large, negative pH-independent zeta-potential of −50 mV (at pH values of from 7 to 13) are hallmarks of polyoxometalate-complexed metal-oxide NCs. Zeta potential is a physical property exhibited by any particle in suspension. It is the charge that develops at the interface between a solid surface and its liquid medium, in other words, the surface charge of nanoparticles in solution. It is an important tool for understanding the state of the nanoparticle surface and predicting the long-term stability of a colloidal dispersion. The unit for Zeta Potential is millivolt (mV). Negative zeta potential indicates that the dispersed particles in the suspension have a negative charge (likewise, positive zeta potential is indicative of positive charged particles).

Full characterization of these macroanion-like complexes entails determining the phase of the encapsulated CuO core and evidence for surface coverage by hexaniobate cluster anions.

First, cryogenic-transmission electron microscopy (cryo-TEM) of Complex 16 in vitrified water (FIG. 13A) revealed 2.4±0.3 nm diameter particles, whose spherical morphology was supported by data from small-angle X-ray scattering. When analyzed by High-resolution TEM (HRTEM) (FIG. 13A, lower right inset), the cores of Complex 16 revealed facets with 2.3 Å fringes, matching the d-spacing of the (111) planes of monoclinic CuO, while selected-area electron diffraction (SAED) (FIG. 13B) featured well-defined rings precisely matching monoclinic CuO. Additional indexed planes were confirmed by fast-Fourier transform.

Monoclinic system is one of the seven structural categories to which crystalline solids can be assigned. A crystal system is described by three vectors or axis, e.g., a, b and c. The axes of crystals in monoclinic system are of unequal lengths, wherein a is perpendicular to band c, but b and c are not perpendicular to each other: they form a rectangular prism with a parallelogram as base. Hence two pairs of vectors are perpendicular, while the third pair make an angle other than 90°. Cu(II)O crystallizes in the monoclinic C_{2/c} space group, wherein Cu²⁺ is bonded in a square co-planar geometry to four equivalent O²⁻ atoms. There are two shorter (1.95 Å) and two longer (1.96 Å) Cu—O bond lengths. O²⁻ is bonded to four equivalent Cu²⁺ atoms to form a mixture of edge and corner-sharing OCu₄ tetrahedra.

Composition of the Cu(II)O core was further confirmed by high-resolution X-ray photoelectron spectroscopy (XPS), which revealed Cu²⁺, but not Cu⁰ or Cu⁺. Based on the core-level Cu 2p spectra, it was confirmed that the NC core of Complex 16 contained Cu²⁺ species (CuO and surface Cu(OH)₂) as demonstrated by deconvoluted spectrum of Cu2p_{3/2}. Further, the Auger spectrum of Complex 16 ruled out the presence of any Cu⁰ or Cu⁺ species.

Elemental mapping by Energy-dispersive X-ray (EDX) analysis revealed Cu and Nb (FIG. 13C) with a Cu:Nb atom-percent ratio of 65:35, effectively identical to the 64:36 ratio obtained by inductively coupled plasma optical emission spectroscopy (ICP-OES). Because the cores of Complex 16 are monoclinic-phase CuO, the hexaniobate anions must reside on their surfaces, rather than represent Nb atoms present as part of the NC core. Due to the small size of the CuO NCs, the hexaniobate ligands could not be imaged by cryo-TEM. However, 1 nm spot EDX analysis of a dried sample material revealed locations predominating in Nb and others in which Cu was more prevalent. Confirmation that the surface-bound niobate structures were intact hexaniobate cluster-anions (Nb₆O₁₉⁸⁻) was established by FTIR and Raman spectroscopy.

The FTIR spectrum of Complex 16 (FIG. 13D, bright curve) is consistent with ligation by Nb₆O₁₉⁸⁻ (FIG. 13D, dark curve), whose terminal Nb═O and bridging Nb-μ-O—Nb moieties account for bands at 860 and 400-750 cm⁻¹, respectively. Additional support for intact Nb₆O₁₉⁸⁻ ligands was provided by FTIR and Raman analysis of the synthetic reaction mixture after precipitation of Complex 16, and after heating K₈Nb₆O₁₉ at 180° C. for 24 h at pH 12, the conditions used to prepare Complex 16.

Although determination of atomic connectivity between ligands and NC surfaces remains a general challenge, polyniobate clusters bind Cu(II) ions in molecular complexes via coordination by bridging oxo atoms of Nb-μ-O—Nb linkages as in Cu(Nb₆O₁₉)₂ (R. P. Bontchev al., Inorg. Chem. 2007, 46, 4483-4491) or by terminal Nb═O ligands as in Cu₂₄(Nb₇O₂₂)₈ (J. Niu et al., Chem. Eur. J. 2007, 13, 8739-8748). Similar interactions may be involved in complexation of hexaniobate ligands to the CuO cores of Complex 16.

Based on 2.4 nm CuO cores (from cryo-TEM), the observed ca. 65:35 Cu:Nb ratio noted above corresponds to 29 hexaniobate ligands on the surfaces of CuO NCs comprised of 350 Cu atoms ([Nb₆O₁₉]⁸⁻₂₉[CuO₃₅₀]). This conclusion is based on the results of a fitting method designed to determine numbers of polyoxometalate ligands on metal-oxide NCs. In the present case, the fitting shows that each hexaniobate ligand lies at the center of an area equal to 0.64 nm², 28% larger than the 0.5 nm² crystallographic “footprint” of the 0.8 nm diameter hexaniobate cluster. Surface coverage by the 29 Nb₆O₁₉⁸⁻ anions is responsible for the pH-invariant −50 mV zeta-potential of Complex 16.

### Example 20

### Synthesis of [Nb₆O₁₉]⁸⁻-Complexed Ni_{0.3}Nb_{0.2}OH_{0.4}Nanoparticles (Complex 17)

In this complex, POM is a hexaniobate and the core nanoparticles are the binary metal hydroxide Ni_{0.3}Nb_{0.2}OH_{0.4} nanoparticles. In this complex, Nb of the nanoparticle core is shared with the ligand, i.e., kind of belongs to both entities NiCl₂·6H₂O (0.0190 g) was dissolved in an aqueous solution containing K₈Nb₆O₁₉·10H₂O (0.0474 g) along with 2.5 equiv. of KOH (taken relative to Ni(II)), providing 10 mL of cloudy green mixture with final concentrations of 8 mM Ni(II) and 3.5 mM Nb₆O₁₉⁸⁻. After stirring for 30 h at room temperature, the solution was transferred to a 23 mL Teflon-lined 316 stainless-steel reaction vessel and heated at 170° C. for 18 h. After cooling to room temperature, the pH 12 solution containing Complex 17 was a clear green with no precipitate.

Isolation and purification of POM complex solution from by-products were carried out as follows. First, precipitating the nano-sized POM-coated Nb_{0.2}Ni_{0.3}OH_{0.4} (Complex 17) by addition of 2 M CsCl was carried out, followed by centrifugation (30 min at 6000 rpm) and re-dispersion of the pellet in pH 10.8 CsOH solution. Then, four “cycles” of precipitation by centrifugation (15 min at 6000 rpm) without adding any salt were performed, after which the pellet was re-dispersed in pH 10.8 CsOH solution.

### Example 21

### Synthesis of [α-PW₁₁O₃₉]⁷⁻ Complexed CrFe₂O₃ Nanoparticles (Complex 18)

In this complex, POM is a heteropolytungstate and the core nanoparticles are the binary metal oxide CrFe₂O₃ nanoparticles. Fe(NO₃)₃ (12 mg, 30 μmol) and Cr(NO₃)₃ (12 mg, 30 μmol) were added as solid to 7 mL deionized water and stirred for an hour. Then, the pH was adjusted to 7.4 with 200 mM NaOH solution (ca. 1.08 mL, 332 μmol), and 200 mM HCl solution (180 μL, 360 μmol), and the solution was stirred for 14 hours. Thereafter, a solution of 40 mM of Na₇[α-PW₁₁O₃₉] (0.75 mL, 30 μmol) was added and the solution was stirred for an additional hour. The final reaction volume was adjusted to 10 mL. Then, the reaction mixture was transferred into Teflon-lined 316 stainless steel reaction vessel and heated in an oven (220° C., 24 hours), and cooled on the bench to room temperature. An optically clear solution containing [α-PW₁₁O₃₉]⁷⁻-complexed CrFe₂O₃ NCs (Complex 18) was obtained.

### Example 22

### Synthesis of Na₈[{α₂-P₂W₁₇O₆₁}In(III)OH)]-Complexed In(OH)₃ Nanoparticles (Complex 19)

In this complex, POM is an OH-substituted heteropolytungstate and the core nanoparticles comprise the metal hydroxide In(OH)₃. Prior measurements of the aqueous speciation of In(III) and stability windows of the monovacant POM anion as a function of the pH, lead to the concision that optimal synthetic conditions should involve the reaction of monovacant Wells-Dawson cluster anions such as [α₂-P₂W₁₇O₆₁]¹⁰⁻ or [α-AlW₁₁O₃₉]⁹⁻ with In(III) at pH values between approximately 5.5 and 9. In water, In(III), present as 8 mM In(NO₃)₃, is an aqua acid that reduces the pH to 2.9. The optimized synthesis of Complex 19 involved the addition of 2.8 equiv of NaOH.

A cloudy white pH-6 colloidal suspension of partially crystalline In(OH)₃ was obtained by stirring indium(III) nitrate (In(NO₃)₃·4·5H₂O; 8 mM) and 2.8 equiv. of NaOH. One-half an equiv. (4 mM) of [α₂-P₂W₁₇O₆₁]¹⁰⁻ were added, followed by stirring for 24 h at room temperature, to obtain a clear and colorless pH 7.5 solution with no precipitate, containing Na₈[{α₂-P₂W₁₇O₆₁}(In(III)OH)]-complexed In(OH)₃ (Complex 19).

Complex 19 was quantitatively separated from soluble inorganic byproducts, including NaNO₃ and molecular POM complexes of In(III), by precipitating the complexed nanoparticles with the addition of NaCl (to a final concentration of 2 M), followed by centrifugation (40 min at 6000 rpm) and re-dissolution in pure water. Five additional cycles of precipitation by addition of NaCl, followed by centrifugation and re-dissolution in pure water were carried out to ascertain that no trace amounts of any reaction byproducts were present. Small amounts of NaCl and any remaining traces of byproducts still present in the solution that precipitated out with the nanoparticles, were removed by extensive dialysis for 24 h against pure water in a 1 L beaker, with the water being periodically exchanged

The proposed binding and orientation of a [α₂-P₂W₁₇O₆₁]In(III)-μ-OH ligand at the surface of a 90% dzhalindite In(OH)₃ NC is schematically shown in FIG. 14. The assignment of the negative charge of the μ-OH ligand to the POM cluster leads to a charge of 8⁻ for the ligand, requiring eight N^{a+} counter cations.

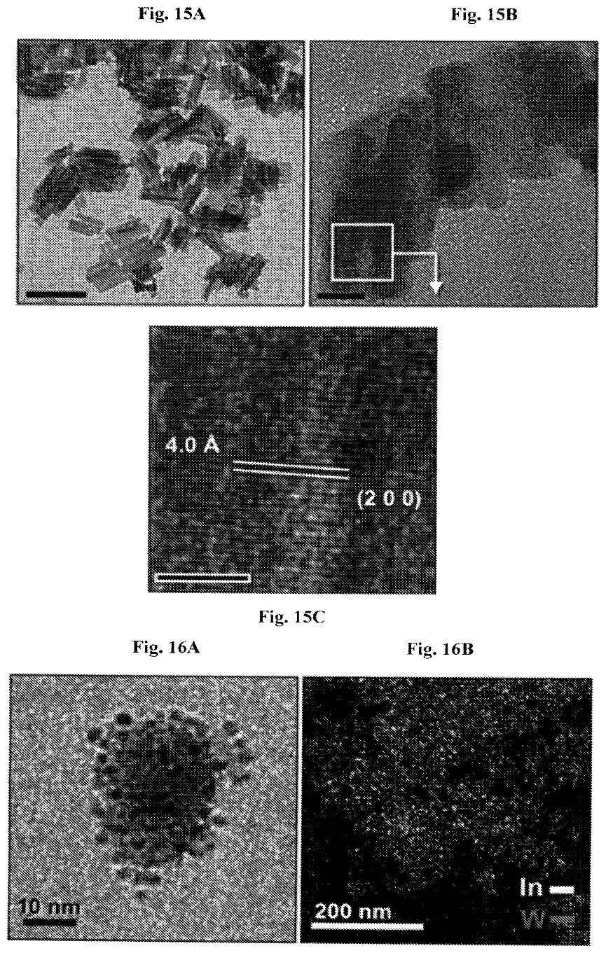

The successful fabrication of the complexes was confirmed by various methods. For example, images from cryogenic-TEM revealed numerous WD ligands at the surfaces of platelike NCs, with average dimensions of 17×28×2 nm. Each NC was complexed by an average of ca. 450 In(III)-substituted WD cluster anions, distributed over the surface of the NC, with each WD anion and it's eight Na⁺ counter-cations allocating a 1.8 nm diameter circle with an area of ca. 2.54 nm² at the crystal surface. Correspondingly, the formal charge of each water-soluble NC was −3,600, which was balanced by an equal number of Na⁺ counter-cations. Characterizing features of the cubic dzhalindite In(OH)₃ phase in the cores of Complex 19 are shown in FIGS. 15A-15C.

For comparison, insoluble, colloidal NCs were prepared by base hydrolysis of In(III) under the same conditions as those used to Complex 19 but with no added POM. This gave the rodlike thin plates shown in the transmission electron microscopy (TEM) images. in FIG. 15A. The TEM images of Complex 19 revealed that the morphologies of the dried particles of Complex 19 (FIG. 15B) resembled the colloidal In(OH)₃ shown FIG. 15A, along with some less elongated NCs. When examined by powder X-ray diffraction, both Complex 19 and the colloidal material prepared with no added POM gave two sharp peaks consistent with the reported XRD patterns of thin layers of dzhalindite In(OH)₃, for which lateral 2D growth is favored in polar solvents.

The magnified region indicated by a white square in FIG. 15B, revealed lattice fringes with an interplane distance of 4.0±0.3 Å (FIG. 15C).

The ζ-potential, energy dispersive X-ray spectroscopy (EDS), and XPS data all document the presence of anionic tungstate-based ligands overcoating In(OH)₃ cores: Cryo-TEM images of Complex 19 in its vitrified solution state revealed individual NCs (FIG. 16A) along with small aggregates. The small, ca. 1-2 nm, objects at the surface of the largely In(OH)₃ cores are WD-anion ligands. Solutions of Complex 19 gave ζ(zeta) potential values of −43 mV, consistent with negatively charged POM ligands. After drying, elemental mapping by electron-dispersive spectroscopy (EDS; FIG. 16B) indicated a homogeneous distribution of W and In atoms. Data from X-ray photoelectron spectroscopy (XPS) of Complex 19 further supported the presence of tungsten oxide-based ligands on In(OH)₃ (results not shown).

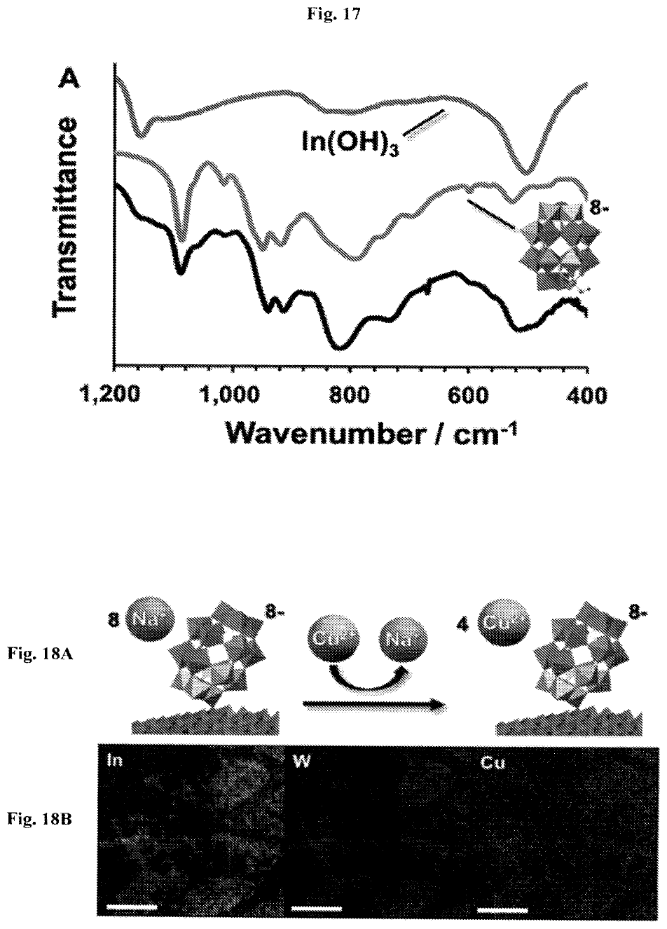

Bonding of the [α₂-P₂W₁₇O₆₁]In(III)OH⁻ ligands via μ-OH linkages to In(III) cations at the In(OH)₃ NC surface, similar to linkages between In(III) ions in molecular complexes, was confirmed by FTIR. A remarkably close match between the FTIR spectra of [α₂-P₂W₁₇O₆₁In(III)OH]⁸⁻ and Complex 19, is shown in FIG. 17 in the green and black plots, respectively. Absorbance from In(OH)₃ is seen at 1162 and 550 cm⁻¹, while bands arising from the WD ligands are observed from 700 to 1100 cm⁻¹.

These data confirm the first reported image of well-defined ligands bound to the surface of a soluble metal hydroxide NC in its native (vitrified) solution state.

### Example 23

### Synthesis of Cu₄[{α₂-P₂W₁₇O₆₁}In(III)OH)]-Complexed In(OH)₃ Nanoparticles (Complex 20)

Attachment of an average of 450 [α₂-P₂W₁₇O₆₁In(OH)]⁸⁻ ligands to each NC perforce in Complex 19, brings eight times as many Na⁺ countercations to locations between or near the WD anions. At the same time, the large negative ζ potential of −43 mV, noted above, points to solution-state dissociation of some of these countercations. This dynamic situation allowed for ready exchange of the inherently present countercations, which led to a straightforward strategy for homogeneously distributing large concentrations of reactive transition-metal cations at or near the surfaces of POM-complexed NCs. In light of previous reports that In(OH)₃ dramatically enhances the Cu-catalyzed electrochemical reduction of CO₂ to CO, the utility of the above-mentioned cation-exchange method was illustrated by replacing the Na⁺ ions of Complex 19 by Cu²⁺. To obtain the Cu-impregnated material, a solution of Complex 19 (Na⁺ salt) was treated with 4 equiv of Cu²⁺ per bound WD ligand (FIG. 17A).

Thus, the Na⁺ counter-cations of the POM ligands of Complex 19 were replaced by Cu²⁺ by adding a concentrated solution of CuCl₂ to a solution containing Complex 19, followed by precipitation, centrifugation, and extraction of the insoluble pellet with water. Additional washing with pure water was used to remove any excess copper cations and to obtain the purified material, Complex 20.

The XRD pattern of the exchanged material confirmed an approximately 90:10% ratio of cubic dzhalindite In(OH)₃ to orthorhombic InOOH. Data from XPS confirmed that Complex 20 comprised of In, O, W, and Cu. Importantly, elemental analysis by ICP-OES also confirmed the presence of four Cu²⁺ ions per WD ligand (the expected W/Cu ratio of 17:4 was obtained), while EDS mapping (FIG. 17B) indicated a homogeneous distribution of Cu²⁺ ions. The inertness of In(III) in the “pocket” toward a possible exchange with Cull was verified by using 31P NMR (results not shown).

Stoichiometrically, ca. 1800 Cu²⁺ ions were dispersed at the surfaces of each NC core.

### Example 24

### Synthesis of [{α₂-AlW₁₁O₃₉}(In(III)OH)]-Complexed In(OH)₃ Nanoparticles (Complex 21)

Nanoparticles were prepared using the same method described for the synthesis of Complex 19 (see Example 22 above), except that [α-AlW₁₁O₃₉]⁹⁻ was used instead of [α₂-P₂W₁₇O₆₁]¹⁰⁻. Addition of solid [α-AlW₁₁O₃₉]⁹⁻ (4 mM) to a colloidal suspension of partially crystalline In(OH)₃, prepared from In(NO₃)₃ (8 mM) with 3.0 equiv. of NaOH and stirring for 24 hours at room temperature, yielded clear colorless solution of Complex 21 with a final pH of 8.8, with no precipitate. Purification and isolation were carried out as described for the isolation and purification of Complex 19. Elemental analysis of Complex 21 by ICP-OES, gave an average W to In atom-percent ratio of 25:75.

### Example 25

### Electrocatalysis by Cu₄[{α₂-P₂W₁₇O₆₁}(In(III)OH)]-Complexed In(OH)₃ NPs

The effect of the In(OH)₃ core of Complex 20 on a model reaction, the Cu-catalyzed electrochemical reduction of CO₂, was evaluated. For this purpose, an ink prepared by combining Complex 20 with isopropyl alcohol and Nafion in water was applied as a thin film to a 1 cm² gas-diffusion layer (GDL) electrode. Specifically, the catalyst ink was prepared by dispersing the catalyst (Complex 20; 9.9 mg) in a mixture of ultrapure water (500 μL), 2-propanol (500 μL), and Nafion solution (5 μL, 5 wt %), followed by sonication for 10 min. The dispersion was then deposited on a square electrode with an area of ca. 1 cm² with a catalyst loading of ca. 1.48 mg cm⁻². The final electrode was obtained by cutting the GDL into an L-shaped piece and attaching it to a silver wire which was covered with plenty of PTFE tape to avoid contact with the solution.

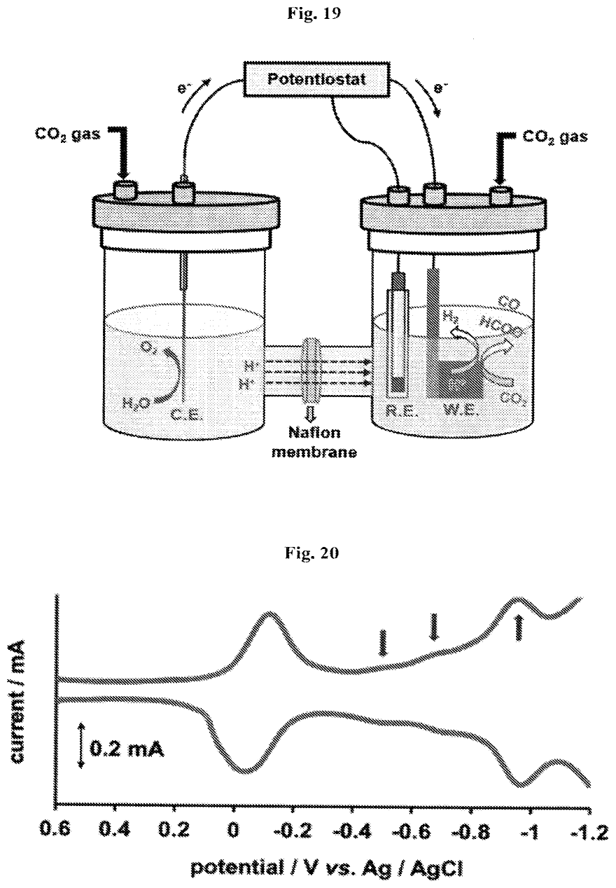

The electrocatalytic activity of Complex 20 was evaluated with a gastight two-compartment cell (illustrated in FIG. 19), using the methods and conditions previously reported for electrocatalytic CO₂ reduction by combinations of Cu and In(OH)₃. The cathodic compartment contained GDL as the working electrode and Ag/AgCl as the reference electrode. The second compartment, separated by a Nafion membrane, contained a Pt-wire counter electrode. Carbon dioxide gas (1 atm) was bubbled into both compartments for 45 minutes prior to electrocatalysis to remove air (O₂) and saturate the bicarbonate solution with CO₂. The electrolyte consisted of potassium bicarbonate (KHCO₃; 0.1 M), which served as a buffer to maintain a near-neutral pH after and during the CO₂ bubbling and later electrocatalysis.

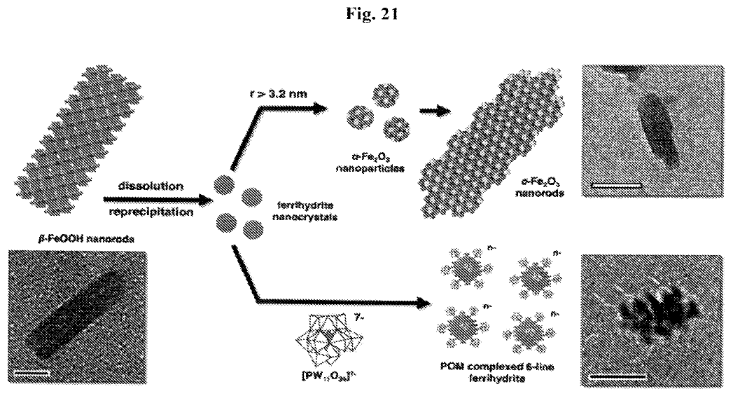

Control experiments were performed using Complex 19 and K₆Cu[P₂Cu(II)(H₂O)W₁₇O₆₁]. Prior to the initiation of electrocatalysis, differential pulse voltammetry (DPV) data revealed the 2e⁻ reduction of Cu(II) to Cu(0) between 0 and −0.1 V (vs Ag/AgCl). On the basis of four Cu²⁺ ions per [α₂-P₂W₁₇O₆₁In(OH)]⁸⁻ ligand in Complex 20, eight electron equivalents were required to reduce all of the Cu²⁺ to metallic Cu⁰, giving a larger current response than those observed for each of the three sequential one-electron reductions of W(VI) atoms in the WD ligands (arrows in FIG. 20), which matched those observed by DPV for solutions of Complex 19. These data show that at the −1.2 V potential (vs Ag/AgCl) subsequently used for electrocatalytic CO₂ reduction, the active species comprised of In(OH)₃ NCs, partially reduced [α₂-P₂W₁₇O₆₁In(OH)]⁸⁻ ligands, and metallic Cu⁰.

For electrocatalysis, a bias voltage of −1.2 V versus Ag/AgCl (−0.6 V versus the reversible hydrogen electrode, RHE, at pH 6.8) was applied for 8 h. During this time, evolved H₂ and CO were quantified by gas chromatography (GC); small amounts of dissolved formate were later quantified by 1H NMR. Electrocatalytic CO₂ reduction by Complex 20 for 8 h gave H₂, CO, and formate in a molar ratio of 82:11:7. To be noted, H₂ is not a product of CO₂ reduction but a byproduct of the competing proton reduction reaction on the cathode (FIG. 20).

Despite a smaller selectivity for CO compared to H₂, the use of POM countercation exchange to obtain an atomically homogeneous dispersion of Cu²⁺ in proximity to the surface of the NC cores of Complex 20 clearly enhanced the selectivity of Cu for the reduction of CO₂ to CO. In addition, the activity itself was improved, which shows the amount of CO produced per milligram of Cu²⁺ in Complex 20 after 8 h of reaction compared with the amount of CO produced per milligram of Cu²⁺ provided by K₆Cu[P₂Cu(II)(H₂O)W₁₇O₆₁], a control compound that includes the WD anion and Cu countercations of Complex 20 but no In(OH)₃. Furthermore, Complex 19, which contains no Cu²⁺, gave much less CO per milligram of In(OH)₃ than Complex 20 did (previously determined).

The results of this model reaction illustrate how POM complexation can provide a potentially general option for achieving atomically homogeneous dispersions of reactive transition-metal cations at or near the surfaces of metal oxide or hydroxide NCs.

### Example 26

### Synthesis of [α-PW₁₁O₃₉]⁷⁻-Complexed 6-Line Ferrihydrite Nanocrystals (Complex 22)

Ferrihydrite, FeOOH, is one of the most important and enigmatic minerals of the iron oxide family. It is a metastable mineral, i.e., thermodynamically unstable (existing at an energy level above that of a more stable state, and requiring the addition of a small amount of energy to induce a transition to the more stable state), and poorly crystalline Fe(III)-oxyhydroxide, which is and an important precursor to more stable goethite and hematite. Ferrihydrite exists exclusively as nanoparticles generally ranging from 2 to 10 nm in size and is thus categorized as a nanomineral.

Despite a plethora of ongoing research, an unequivocal description of the structure and composition of ferrihydrite remains elusive. Part of the challenge stems from the fact that ferrihydrite is variable in crystallinity and composition, being sensitive to the conditions of its formation and, hence, requiring careful control over temperature, pH, and the presence, type, and concentration of other ions in solution. The extent of structural ordering is generally categorized on the basis of the number of reflections present in the XRD pattern, yielding the convention of either two-line or six-line ferrihydrite. Generally accepted notions about differences between two- and six-line ferrihydrite include that the former is more hydrated, with a OH/Fe ratio close to 1, is less ordered, and is the preferred phase for small particle sizes of about 3-4 nm.

The structure of six-line ferrihydrite, which tends to be favored during precipitation at mildly elevated temperature, is controversial with respect to the presence of tetrahedrally coordinated iron.

The β-FeOOH precursor was prepared as a colloidal suspension by adding solid FeCl₃·6H₂O (0.542 g, 2.0 mmol) under vigorous stirring to a 0.002 M HCl solution (100 mL) at 100° C. The solution was refluxed while stirring at 100° C. for 30 min, followed by cooling to room temperature. The obtained solution was dark red with a pH of approximately 1.3. Next, the pH of 7 mL β-FeOOH solution was adjusted to 7.30 by addition of a 0.2 M NaOH solution (2.1 mL) and the solution was left to stir. After an hour, 0.75 mL of Na₇[PW₁₁O₃₉] solution (final concentration 40 mM) was added as a single portion with stirring. After one hour our stirring, the pH of the solution had decreased to 6.35, after which the pH was adjusted to 6.50 using 0.2 M NaOH. The overall volume was increased to 10 mL by addition of water, and the solution was transferred to a Teflon lined stainless-steel reaction vessel and heated in an autoclave at 220° C. for 24 hours. Upon cooling to room temperature, the contents of the reaction vessel that were decanted into a falcon tube, consisted of a precipitate, which was separated and discarded, and a light-yellow solution (pH 6.8) that contained the desired product, unreacted [PW₁₁O₃₉]⁷⁻ and [PFeW₁₁O₃₉]⁴⁻. The main product, was separated from the solution via precipitation induced by the addition of NaCl (final conc. 2M), followed by centrifugation, resulting in a brown pellet. After centrifugation, the supernatant was discarded and the pellet was re-dissolved in 10 mL of pure water. This precipitation/dissolution processes was carried out three times in order to remove trace contaminants, and then dialyzed against water for 24 hours (final pH was 5.90). The final product was an optically clear brown solution of [α-PW₁₁O₃₉]⁷⁻ complexed ferrihydrite (Complex 22).

POM entrapment and thermal stabilization of Complex 22 was established as follows (illustrated in FIG. 21): at 220° C., soluble β-FeOOH nanorods (shown in the cryo-TEM image, bottom left in FIG. 21) underwent a process of dissolution and reprecipitation, initially forming ferrihydrite. In the absence of POM ligands, growth of the ferrihydrite NCs to a critical radius of 3.2 nm resulted in transformation to α-Fe₂O₃ (hematite) NCs that coalesced into larger α-Fe₂O₃ nanorods (top pathway in FIG. 21. Top right is a cryo-TEM image of the α-Fe₂O₃ nanorods). However, when small ferrihydrite particles were entrapped by POMs, they did not reach the critical radius of phase transformation to hematite (bottom pathway in FIG. 21), and, instead, formed the NP cores of the soluble, entirely inorganic Complex 22. The bottom right image in FIG. 21, is a cryo-TEM image showing POMs at the surface of a NC (indicated by red arrows). Color code: Fe(III)-centered polyhedra are orange (or green, for ease of layer packing distinction), W(VI)-centered octahedra are yellow, P(V)-centered tetrahedra is in red.

### Example 27

### Preparation of Organic-Solvent Soluble Forms of Complex 22 by Cation Exchange

First, the concentration of the POM ligands in a solution of Complex 22 was determined based on the amounts and ratio of W:Fe obtained from ICP-OES in combination with the size of the nanoparticles observed by TEM. Then, a slightly sub-stoichiometric amount of tetrahexylammonium bromide (THABr) (relative to the POM concentration and considering a 4⁻ charge per POM ligand) was added to give an oily orange precipitate. The use of sub-stoichiometric amount of THABr was done in order to prevent excess of counter-cations upon dissolution in MeCN (acetonitrile). Centrifugation of the cloudy solution gave an orange pellet, with the supernatant containing some unprecipitated Complex 22 that did not undergo cation exchange. Next, the pellet was redissolved in analytical grade (99%+) MeCN. A concentration of 0.047 g·mL⁻¹ was readily achieved and used as a stock solution for transfer into other organic solvents.

Dynamic light scattering of the solution showed a number-weighted diameter of ca. 13 nm, with a small population at ca. 38 nm. The phase stability of Complex 22 in MeCN, investigated by PXRD, cryo-TEM and SAED, showed no change of the 6-line ferrihydrite phase upon transfer to MeCN. The solution was stable for months at room temp. and could be stored indefinitely at 4° C.

The MeCN stock solution of the THA-cation form of Complex 22 was used to dissolve the complex in other organic solvents. Specifically, dissolution of 0.187 g of the THA-cation form of Complex 22 in 4 mL MeCN gave a clear, deep-brown colored solution. A 50 μL aliquot of the original MeCN solution was then added to: (a) 950 μL of tetrahydrofuran (THF); (b) a mixture of 150 μL MeCN and 800 μL dichloromethane (DCM); and (c) a mixture of 200 μL MeCN and 750 μL toluene. In all cases, clear solutions were obtained. Solutions of Complex 22 in 95% v/v THF and 80% v/v DCM were stable for months, while the solution in 75% v/v toluene was stable for several weeks.

Polyoxometalate ligands entrap and stabilize 6-line ferrihydrite nanocrystals in aqueous solution even at at 220° C. This facile use of POMs as stabilizing ligands for a metastable phase opens possibilities for the exploration of materials otherwise inaccessible through simple solution-state methods, and lays a foundation for future research in the exploration and utilization of metastable phases of metal oxide-based NCs as the cores of inherently reactive macro-anion like complexes, and as building blocks for the fabrication of multi-component functional materials.

1. A complex of the Formula (I):
(Qₗ[i-POM])ₘ[NPᵣ]
wherein
NP is the core of the complex comprising a plurality of optionally particulate compounds (nanoparticles) selected from the group consisting of metal oxide, metal oxy-hydroxide and metal hydroxide;
POM is a polyoxometalate ligand, optionally covalently attached to the complex core nanoparticles;
Q is H, an alkali metal cation or an organic cation;
l is the relative amount of Q, which counter-balances the charge of POM, and is an integer of 1 to 40;
m is the number of POM ligands bound to an individual NP, and is a number between 1 to 10,000;
r is the number of metal-oxide, metal oxy-hydroxide and/or metal hydroxyde compounds in NP, ranging from 50 to 6,000,000; and
i is absent or a specific POM isomer,
but excluding the POM metal oxide complexes: (α-Q₄[PTiW₁₁O₄₀])₅₅[(TiO₂)₁₈₀₀], (Q₅[α-SiTiW₁₁O₄₀])_{˜55}[(TiO₂)_{˜1800}], (Q₅[α-PFeW₁₁O₄₀])₁₅[(Fe₂O₃)₅₅₀], (Q₆[α-SiFeW₁₁O₄₀])_{˜15}[(Fe₂O₃)_{˜550}], (Q₆[AlFeW₁₁O₄₀])_{˜15}[(Fe₂O₃)_{˜550}], (Q₈[α₂-P₂FeW₁₇O₆₂])_{˜15}[(Fe₂O₃)_{˜550}], (Q₅[α-PFeW₁₁O₄₀])₆[(γ-FeOOH)₂₇₅] and (Q₈[α₂-P₂FeW₁₇O₆₂])_{˜15}[(γ-FeOOH)_{˜275}].

2. (canceled)

3. The complex of claim 1, wherein POM is presented by the Formula (Ia):
[X_{z}MₚC_{d}O_{y}]ⁿ⁻
wherein
X is H, at least one heteroatom and/or at least one metal atom;
M is at least one transition and/or main-group metal cation, optionally, in a high oxidation state;
C is H, OH, OH₂, a lower alkyl, lower hydroxyalkyl, lower silylalkyl, lower silylalkoxy or carboxylate; and
z is 0 to 100; p is 6 to 250; d is 6 to 100; and y is 15 to 800.

4. The complex of claim 3, characterized by at least one of:
(i) X is at least one heteroatom selected from P, S or Si, or at least one metal atom elected from Cd, Mn or Al; or
(ii) C is C₁-C₃ alkyl, C₁-C₃ hydroxyalkyl or carboxylate.

5. (canceled)

6. The complex of claim 1, wherein the complex core (NP) comprises at least one of:
(a) a plurality of metal oxide compounds, each having the empirical chemical formula presented by Formula (Ib):
MᵢM′ⱼM″_{f}Oₖ;
(b) a plurality of metal oxy-hydroxide compounds, each having the empirical chemical formula presented by Formula (Ic):
MᵢM′ⱼM″_{f}Oₖ(OH)ₜ; or
(c) a plurality of metal hydroxide compounds, each having the empirical chemical formula represented by Formula (Id):
MᵢM′ⱼM″_{f}(OH)ₜ,
wherein M, M′ and M″, each independently, is a metal cation;
i, j, and f, representing the relative amounts of metal cations M, M′ and M″, respectively, each independently, is 0, an integer or a fraction in the range of from 1 to 20, provided that at least one of i, j, or f is not 0; and
k is an integer or a fraction in the range of from 1 to 20; and t is an integer or a fraction in the range of from 1 to 20.

7. The complex of claim 6, wherein:
(a) the metal oxide compound is at least one of MᵢOₖ or MᵢM′ⱼOₖ;
(b) the metal oxy-hydroxide compound is MᵢOₖ(OH)ₜ; or
(c) the metal hydroxide compound is at least one of Mᵢ(OH)ₜ or MᵢM′ⱼ(OH)ₜ,
wherein i, j, k and t, each independently, is an integer or a fraction in the range of from 1 to 8 or from 1 to 3.

8. The complex of claim 7, wherein:
(a) the metal oxide is at least one of MnO₂, SnO₂, CeO₂, ZrO₂, CuO, TiO₂ or HfO₂ or at least one of BaTiO₃, SrTiO₃, LiNbO₃, KNbO₃, LiTaO₃, NiNbO₃H, Fe₂O₃ with Cr(III) as dopant, or TiᵢSnⱼOₖ;
(b) the metal oxy-hydroxide compound is AlO(OH) or GaO(OH); or
(c) the metal hydroxide compound is at least one of In(OH)₃, Co(OH)₂, Ni(OH)₂, Al(OH)₃, Ga(OH)₃ or Sc(OH)₂.

9-17. (canceled)

18. The complex of claim 1, wherein the complex core (NP) is a nanocrystal selected from single crystal and polycrystal, or amorphous nanoparticle.

19. The complex of claim 6, wherein M, M′ and M″, each independently, is Li(I), Na(I), K(I), Ag(I), Ba(II), Cd(II), Ca(II), Fe(II), Fe(III), Sr(II), Ti(III), Ti(IV), Zr(IV), Nb(V), Nb(III), Hf(IV), Ta(V), Mn(III), Mn(IV), Mo(II), Mo(III), Mo(IV), Re(II), Re(III), Re(IV), Re(V), Re(VI), Re(VII), W(IV), W(V), V(II), V(III), V(IV), V(V), Cr(III), Cr(IV), Cr(V), Ru(II), Ru(III), Ru(IV), Ru(V), Co(II), Co(III), Rh(I), Rh(III), Ir(IV), Ni(II), Pt(II), Pt(IV), Pd(II), Pd(IV), Zn(II), Cu(I), Cu(II), Pb(II), Pb(IV), Al(II), Al(III), Ga(II), Ga(III), In(III), Sn(II), Sn(IV), Sc(II), Sc(III), Au(IV), Au(V), Au(VI) or Ce(IV).

20. (canceled)

21. The complex of claim 1, being thermodynamically stable in water at pH 2 to 8.

22. The complex of claim 21, wherein the complex is stable to oxidation, hydrolysis, aggregation and/or ligand exchange.

23. The complex of claim 1, wherein at least one metal cation in the POM ligand is bound in an “out-of-pocket” fashion.

24. The complex of claim 23, wherein the out-of-pocket metal cation forms oxide and/or hydroxide linkages to one or more metal cations on the NP surface.

25. The complex of claim 1, wherein:
POM is a heteropolytungstate and NP comprises MnO₂;
POM is a heteropolytungstate and NP comprises SnO₂;
POM is a hexaniobate and NP comprises SnO₂;
POM is a heteropolytungstate and NP comprises CeO₂;
POM is a heteropolytungstate and NP comprises ZrO₂;
POM is a heteropolytungstate and NP comprises HfO₂;
POM is a hexaniobate and NP comprises CuO;
POM is a hexaniobate and NP comprises TiO₂;
POM is a hexaniobate and NP comprises Co(OH)₂;
POM is a hexaniobate and NP comprises NiNbO₃H;
POM is a heteropolytungstate and NP comprises CrFeO₃;
POM is a hexaniobate and NP comprises TiᵢSnⱼOₖ, wherein i, j and k, each vary from 5 to 100% of the metal-cation composition; or
POM is a heteropolytungstate and NP comprises Fe₂O₃ with Cr(III) as dopant.

26. The complex of claim 1, wherein the POM is an optionally substituted POM having a Lindqvist, Keggin, Anderson or Wells-Dawson (WD) structure.

27. (canceled)

28. The complex of claim 26, wherein the POM is a Wells-Dawson (WD) cluster anion, optionally substituted with a metal hydroxide.

29-30. (canceled)

31. The complex of claim 28, wherein the POM is the substituted WD cluster anion [{α₂-P₂W₁₇O₆₁}(In(III)OH)]⁸⁻.

32. The complex of claim 25, selected from the group consisting of:
[α-PW₁₁O₃₉]⁷⁻-complexed SnO₂ nanoparticles (Complex 1);
[Nb₆O₁₉]⁸⁻-complexed SnO₂ nanoparticles (Complex 2);
[Nb₆O₁₉]⁸⁻-complexed Sn_{0.5}Ti_{0.5}O₂ nanoparticles (Complex 3);
[Nb₆O₁₉]⁸⁻-complexed Sn_{0.25}Ti_{0.75}O₂ nanoparticles (Complex 4);
[Nb₆O₁₉]⁸⁻-complexed Sn_{0.13}Ti_{0.87}O₂ nanoparticles (Complex 5);
[Nb₆O₁₉]⁸⁻-complexed TiO₂ nanoparticles (Complex 6);
[α-PW₁₁O₃₉]⁷⁻-complexed Sn_{0.13}Ti_{0.87}O₂ nanoparticles (Complex 8);
[α-AlCr(V)W₁₁O₄₀]⁶⁻-complexed ε-MnO₂ nanoparticles (Complex 11);
[α-PW₁₁O₃₉]⁷⁻-complexed CeO₂ nanoparticles (Complex 12);
[α-PW₁₁O₃₉]⁷⁻-complexed ZrO₂ nanoparticles (Complex 13);
[α-PW11O39]⁷⁻-complexed HfO₂ nanoparticles (Complex 14);
[Nb₆O₁₉]⁸⁻-complexed Co(OH)₂ nanoparticles (Complex 15);
[Nb₆O₁₉]⁸⁻-complexed CuO nanoparticles (Complex 16);
[Nb₆O₁₉]⁸⁻-complexed Ni_{0.3}Nb_{0.2}OH_{0.4} nanoparticles (Complex 17);
[α-PW₁₁O₃₉]⁷⁻-complexed CrFe₂O₃ nanoparticles (Complex 18);
Na₈[{α₂-P₂W₁₇O₆₁}(In(III)OH)]-complexed In(OH)₃ nanoparticles (Complex 19);
Cu₄[{α₂-P₂W₁₇O₆₁}(In(III)OH)]-complexed In(OH)₃ nanoparticles (Complex 20);
[{α₂-AlW₁₁O₃₉}(In(III)OH)]-complexed In(OH)₃ nanoparticles (Complex 21); and
[α-PW₁₁O₃₉]⁷⁻-complexed 6-line ferrihydrite nanoparticles (Complex 22).

33. The complex of claim 32, wherein [{α₂-P₂W₁₇O₆₁}(In³⁺OH)]⁸⁻ is bound to In(III) cations of the In(OH₃) nanocrystals via OH ligand on the POM.

34. The complex of claim 1, operable as at least one of:
(i) soluble, visible-light driven water-oxidation catalysts (WOCs) for at least 7 days; or
(ii) stabilizer of metastable phase of crystals.

35-36. (canceled)

37. An aqueous solution comprising a complex according to claim 1, in a concentration in a range of from 8% to 20% w/v.
